(19) United States
(12) Patent Application Publication
(10) Pub. No.: US 2020/0376806 A1
(43) Pub. Date: Dec. 3, 2020

(54) CEMENTITIOUS COMPOSITE MAT

(71) Applicant: Cortex Composites, Inc., Pacific Palisades, CA (US)

(72) Inventor: Curren E. Krasnoff, Pacific Palisades, CA (US)

(73) Assignee: Cortex Composites, Inc., Pacific Palisades, CA (US)

(21) Appl. No.: 16/605,084

(22) PCT Filed: Apr. 17, 2018
(86) PCT No.: PCT/US2018/027984

§ 371 Date: Oct. 14, 2019

Related U.S. Application Data
(60) Provisional application No. 62/487,351, filed on Apr. 19, 2017.
(60) Provisional application No. 62/529,557, filed on Jul. 7, 2017.
(60) Provisional application No. 62/628,763, filed on Feb. 9, 2018.

(51) Int. Cl. B32B 13/02; B32B 7/12; B32B 5/06; B32B 37/12; C04B 40/06; B32B 7/09; C04B 20/00

(52) U.S. Cl. CPC B32B 13/02; B32B 7/12; B32B 5/06; B32B 37/1207; C04B 40/0616; C04B 2111/0075; C04B 20/0048; B32B 2250/05; B32B 2315/06; B32B 2307/714; B32B 2307/7265; B32B 7/09

(57) ABSTRACT

A cementitious composite for in-situ hydration includes a first layer, a second layer, a cementitious mixture, and an adhesive layer. The cementitious mixture is disposed along the first layer. The cementitious mixture includes a plurality of cementitious particles. The second layer is disposed along the cementitious mixture, opposite the first layer. The adhesive layer is positioned to secure at least one of (i) the first layer to the cementitious mixture, (ii) the second layer to the cementitious mixture, and (iii) the first layer and the second layer together. The first layer and the second layer are configured to at least partially prevent the plurality of cementitious particles from migrating out of the cementitious composite.

### CROSS-REFERENCE TO RELATED PATENT APPLICATIONS

This application claims the benefit of U.S. Provisional Patent Application No. 62/487,351, filed Apr. 19, 2017, U.S. Provisional Patent Application No. 62/529,557, filed Jul. 7, 2017, and U.S. Provisional Patent Application No. 62/628,763, filed Feb. 9, 2018, all of which are incorporated herein by reference in their entireties.

### BACKGROUND

The present application relates to a cementitious composite for in-situ hydration (i.e., hydration in place, on location, on a construction site). In-situ hydration occurs as a liquid is topically applied and reacts with a volume of cementitious material within the cementitious composite. This reaction occurs while the cementitious composite is in a position and does not change the directional orientation of the pre-fabricated nature of the cementitious composite. Such a cementitious composite allows cementitious material to set and harden within the cementitious composite without requiring traditional mixing and pour procedures.

Textile-reinforced composites may include at least one layer of a two or three-dimensional textile and a layer of cementitious material to form a laminated composite, where traditionally the textiles are layered in a planer form. Such laminated composites may exhibit excellent in-plane properties but typically lack reinforcement in the thickness direction (i.e., a direction orthogonal to a surface of the composite) or have reduced bonding of the layers. While traditional cement composites may include plain weave fabrics or multiple layers of fabric to improve performance, these systems may fail (e.g., delaminate, etc.) under loading.

Other cementitious composites include “spacer fabric” composites having monofilament threads or yarns which are ideally elastomeric, woven between two layers to create a fabric with a spaced apart arrangement configured to entrap cementitious material between the two layers. The outer layers are each porous to allow the yarns, threads, etc. to be threaded through the outer layers, where the yarns, threads, etc. are fed through the pores of the layers. Additional, less porous fabrics or membranes may be attached to the outer layers of the spacer fabric to reduce the size of openings on each layer and prevent the cementitious material from escaping the composite. Adhesive may be required to attach the additional, less porous fabric layers. The yarns of the spacer fabric do not provide a structure to which other layers may be attached. The yarns must be woven between porous outer layers having apertures arranged in a set configuration designed for the yarn to thread though. Such spacer fabric cementitious composites are labor intensive to manufacture.

### SUMMARY

One exemplary embodiment relates to a cementitious composite for in-situ hydration. The cementitious composite includes a first layer, a second layer, a cementitious mixture, and an adhesive layer. The cementitious mixture is disposed along the first layer. The cementitious mixture includes a plurality of cementitious particles. The second layer is disposed along the cementitious mixture, opposite the first layer. The adhesive layer is positioned to secure at least one of (i) the first layer to the cementitious mixture, (ii) the second layer to the cementitious mixture, and (iii) the first layer and the second layer together. The first layer and the second layer are configured to at least partially prevent the plurality of cementitious particles from migrating out of the cementitious composite.

Another exemplary embodiment relates to a cementitious composite for in-situ hydration. The cementitious composite includes a first layer, a second layer, and a cementitious mixture. The cementitious mixture is disposed along the first layer. The cementitious mixture includes a plurality of cementitious particles. The second layer is disposed along the cementitious mixture, opposite the first layer. The first layer and the second layer are configured to at least partially prevent the plurality of cementitious particles from migrating out of the cementitious composite. The first layer and the second layer are secured to at least one of a structure layer and each other using at least one of a quilting process and a needle punching process.

Still another exemplary embodiment relates to a cementitious composite for in-situ hydration. The cementitious composite includes a single outer layer having a first end and an opposing second end, and a cementitious mixture disposed along the single outer layer. The first end and the opposing second end of the single outer layer are coupled together to enclose the cementitious mixture within the single outer layer.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description taken in conjunction with the accompanying drawings wherein like reference numerals refer to like elements, in which:

FIG. 1 is a perspective view of operators installing a cementitious composite in a canal lining application, according to an exemplary embodiment;

FIG. 2 is an exploded perspective view of a cementitious composite, according to an exemplary embodiment;

FIG. 3 is a perspective view of a rolled cementitious composite, according to an exemplary embodiment;

FIG. 4 is a schematic cross-sectional views of the cementitious composite of FIG. 2, according to an exemplary embodiment;

FIGS. 5-8 are various cross-sectional illustrations of internally-injected adhesive within the cementitious composite of FIG. 2, according to various exemplary embodiments;

FIG. 9 is a schematic illustration of an adhesive grid for use with the cementitious composite of FIG. 2, according to an exemplary embodiment;

FIG. 10 is a schematic cross-sectional view of the cementitious composite of FIG. 2 having the grid of FIG. 9, according to an exemplary embodiment;

FIG. 11 is a schematic cross-sectional view of the cementitious composite of FIG. 2 prior to activation of adhesive particles, according to an exemplary embodiment;

FIG. 12 is a schematic cross-sectional view of the cementitious composite of FIG. 2 following activation of adhesive particles, according to an exemplary embodiment;

FIG. 13 is an exploded perspective view of a cementitious composite, according to an exemplary embodiment;

FIGS. 14A and 14B are schematic cross-sectional views of the cementitious composite of FIG. 13, according to various exemplary embodiments;

FIG. 15 is an exploded perspective view of a cementitious composite, according to another exemplary embodiment;

FIG. 16A is a schematic cross-sectional view of the cementitious composite of FIG. 15 prior to activation, according to an exemplary embodiment;

FIG. 16B is a schematic cross-sectional view of the cementitious composite of FIG. 15 following activation, according to an exemplary embodiment;

FIG. 17 is an exploded perspective view of a cementitious composite, according to another exemplary embodiment;

FIG. 18 is a schematic cross-sectional view of the cementitious composite of FIG. 17, according to an exemplary embodiment;

FIGS. 19A-19E are various views of a quilted cementitious composite, according to various exemplary embodiments;

FIGS. 20A-20C are cross-sectional views of a needle punching process performed on a cementitious composite, according to an exemplary embodiment;

FIGS. 21A-21C are cross-sectional views of a cementitious composite, according to another exemplary embodiment;

FIG. 22 is a flow diagram of a method for manufacturing a sewn cementitious composite, according to an exemplary embodiment; and

FIG. 23 is a flow diagram of a method for manufacturing a sewn cementitious composite, according to another exemplary embodiment.

### DETAILED DESCRIPTION

Before turning to the figures which illustrate the exemplary embodiments in detail, it should be understood that the application may be not limited to the details or methodology set forth in the description or illustrated in the figures. It should also be understood that the terminology may be for the purpose of description only, and should not be regarded as limiting.

### Composite Layers

Cementitious composite mats may provide enhanced structural performance relative to concrete reinforced with traditional materials (e.g., fibers, rebar, etc.), traditional unidirectional textile reinforced concrete composites, and woven or knitted three-dimensional textile concrete composites. Cementitious composite mats may include a dry cementitious mixture embedded in, and/or contained by, a structural layer. The structural layer may be positioned between an impermeable layer and a permeable layer. The cementitious mixture undergoes its normal setting and strength gain process after in-situ hydration to produce a rigid composite. The permeable layer may hold water (e.g., for a controlled period of time, etc.) for improved curing of the cementitious composite mat (e.g., facilitating the release of water into the cementitious mixture over a period of time, etc.). Unlike traditional concrete, cementitious composite mats do not require the cementitious portion to be mixed (e.g., in a standalone mixer, in a cement mixer truck, etc.). The cementitious mixture of the present application does not wash from the cementitious composite mat as easily (e.g., not at all, etc.) as traditional, non-formulated cementitious mixtures and remains secured within the cementitious composite mat such that it hardens in place without needing to be mixed. The cementitious mixture is disposed between the permeable and impermeable layers and may include accelerators, retarders, latex modifiers, curing modifiers, other modifiers, fibers, glass additives, metal additives, stone additives, organic additives, water reducing admixtures, shrinkage reducing admixtures, viscosity modifiers, absorbent materials (e.g., superabsorbent materials, superabsorbent polymers, superabsorbent clays, etc.), interconnection particles (e.g., beads, pellets, strands, etc.; made of a resin, a polymer, elastomeric polymer, PVC, polypropylene, polyethylene, a metal or metal alloy having a low melting point, etc.), adhesives, and/or other gel forming additives so the cementitious mixture remains stationary when hydrated. A cementitious mixture that remains stationary facilitates using a top layer (e.g., permeable layer, etc.) that dissolves upon hydration and/or that has apertures.

The structural layer of the cementitious composite mat may be formed into, or include an independent, free-standing material (e.g., the structural layer, etc.). The structure layer may improve load bearing capabilities of the cementitious composite mat by distributing the energy of a load across the structural layer. The structure layer may also bridge crack faces in the cementitious phase to provide improved crack resistance and/or localize cracking to reduce crack propagation. The structural layer may be coupled to at least one of the permeable layer and the impermeable layer with an adhesive, a heat treatment process, and/or mechanically (e.g., barbs, fibers, etc.). In some embodiments, the structural layer is at least partially manufactured from an adhesive material. In some embodiments, the cementitious composite does not include the structural layer, but rather the adhesive layer functions as a structural layer. Cementitious composite mats having the structural layer may provide improved structural performance per unit of volume, have a lower cost, reduce labor costs, require less processing than other concrete or concrete composite, reduce the possibility of variation in specification compared to poured concrete, and/or eliminate the disadvantages of traditional wet mixing (e.g., range constraints for delivery with a concrete mixer vehicle, etc.), among having other advantages. In addition to holding the cementitious composite mat together and/or retaining the cementitious mixture (e.g., pre-hydration, etc.), the structural layer may structurally reinforce the cementitious layer and/or cementitious composite mat post-hydration. In some embodiments, the cementitious composite mat does not include the structure layer.

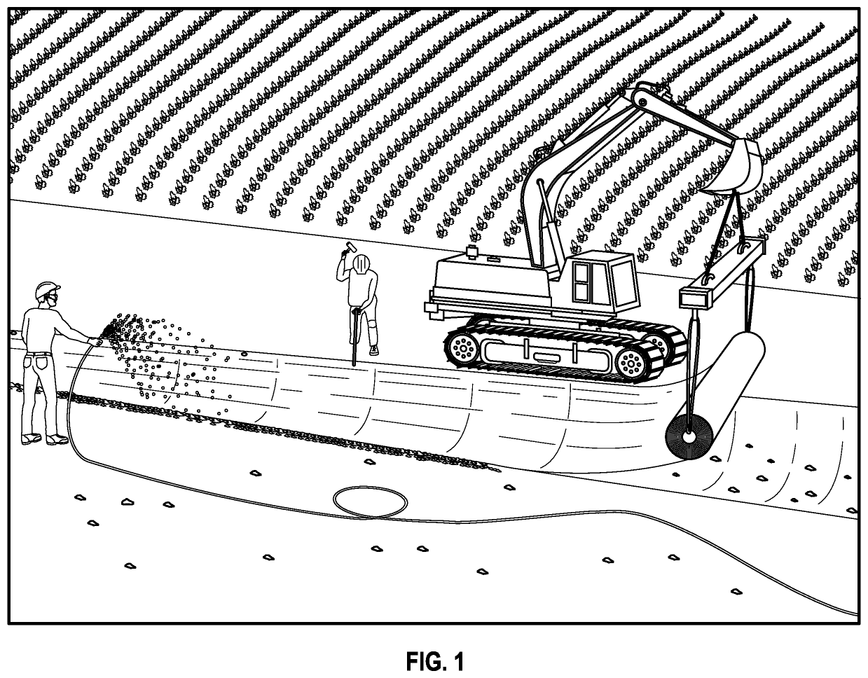

Hydration of cementitious composite mats may be initiated in-situ (e.g., in place, on a job site, etc.). The cementitious composite mat may be transported to a location (e.g., canal, etc.) as a flexible composite material in a pre-packaged configuration (e.g., sheets, rolls, etc.) and hydrated on-location. Such cementitious composite materials may provide commercial, water conservation, and operational benefits. By way of example, cementitious composite mats may be applied to form a canal lining, as shown in FIG. 1. Other applications for cementitious composite mats may include the following: low to high flow channels, open-channel water conveyance canals, irrigation and drainage ditches, swales, culverts, jetties, groins, dikes, levees, reservoirs, check dams, interceptor ditches, horizontal drains, stream restoration and storm water management, seawall and bulkhead scour protection, landfill layering and capping, brown field layering and capping, mine shaft reinforcement, structural reinforcement, airfield or helipad construction, boat launch ramps, column and beam reinforcement, pipe repair, oilfield lining, holding basins, pond lining, pit lining, waste water lagoon lining, slope fortification, snow basin fortification, tieback fortification, berm lining, beach and shoreline restoration, as a road surface, driveways, sidewalks and walkways, form work lining, concrete waterproofing, a material for homes or other structures, landscaping, foundation linings, flooring, pool construction, patio construction, roofs, insulation and weatherproofing, as a replacement for stucco, for noise attenuation, and for retaining wall and embankment construction, among other applications.

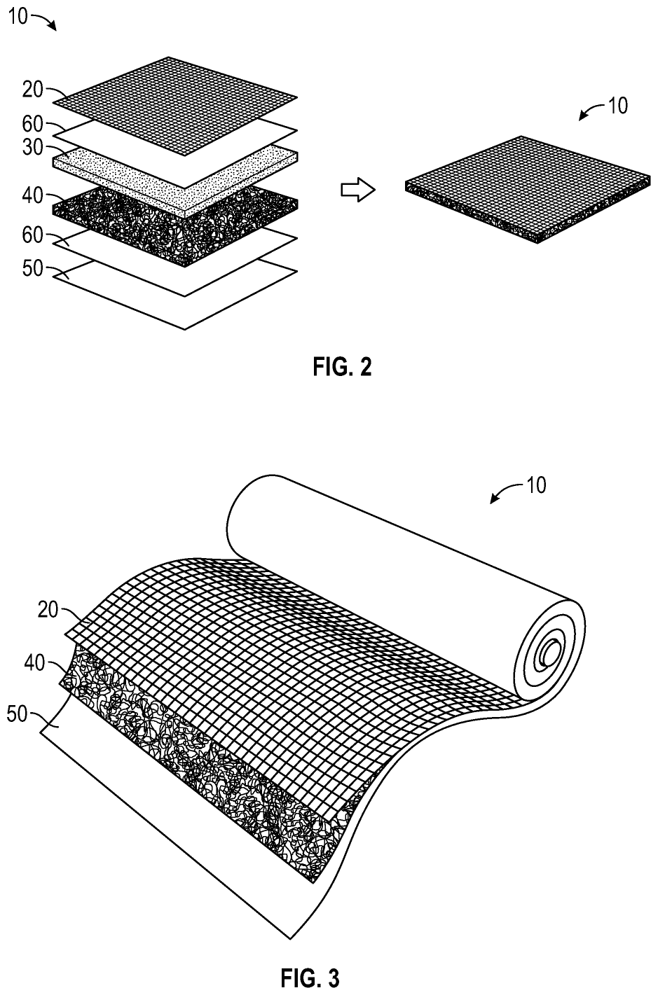

According to the exemplary embodiment shown in FIG. 2, a composite mat, shown as cementitious composite 10, includes a plurality of layers. As shown in FIG. 2, such layers include a containment layer, shown as permeable layer 20; a cementitious layer, shown as cementitious mixture 30; a three-dimensional volume layer (e.g., a bunching layer, a mesh layer, a grid layer, a nonwoven layer, a not woven layer, a nonfibrous layer, a fiberless layer, pins and/or connectors, interconnecting particle layer, a coiled layer, a tube layer, a 3D knitted and/or woven layer, a plastic layer, a metal layer, a layer configured for integration with one or more snap-fit connections, etc.), shown as structure layer 40; an impermeable (e.g., sealing, etc.) layer, shown as impermeable layer 50; and one or more adhesive layers, shown as adhesive layer 60. According to an exemplary embodiment, permeable layer 20, cementitious mixture 30, structure layer 40, impermeable layer 50, and/or adhesive layer 60 are disposed adjacent to one another and assembled into a sheet to form cementitious composite 10. As shown in FIG. 2, structure layer 40 may be disposed between (e.g., sandwiched between, etc.) permeable layer 20, impermeable layer 50, and adhesive layer 60. In some embodiments, the cementitious composite 10 does not include structure layer 40. In such embodiments, adhesive layer 60 may function as a structure layer. According to an exemplary embodiment, cementitious composite 10 has a thickness of between five millimeters and one hundred millimeters pre-hydration. The thickness of cementitious composite 10 may exceed the pre-hydration thickness after hydration when, by way of example, additives are included in cementitious mixture 30 (e.g., expansive cement, etc.). It should be understood that reference to a structure layer, an adhesive layer, and/or a cementitious mixture may include any structure layer, adhesive layer, and/or cementitious mixture disclosed herein.

According to an exemplary embodiment, cementitious composite 10 includes layers that are coupled together (e.g., adhesively coupled, sewn, etc.). Such coupling may reduce the relative movement between the layers pre-hydration (e.g., during the manufacturing process, during transportation, during installation, etc.). By way of example, impermeable layer 50 may be coupled (e.g., selectively joined, etc.) with structure layer 40 and/or cementitious mixture 30 with adhesive layer 60. By way of another example, permeable layer 20 may be coupled (e.g., selectively joined, etc.) with structure layer 40 and/or cementitious mixture 30 with adhesive layer 60. By way of another example, impermeable layer 50 may be coupled to permeable layer 20 (e.g., sewn together, etc.). Such coupling may improve the structural characteristics of cementitious composite 10 by facilitating load transfer between permeable layer 20, structure layer 40, adhesive layer 60, and/or impermeable layer 50. Adhesive layer 60 and/or structure layer 40 may serve as a bonding medium. Various structure layers and/or adhesive layers may reduce the risk of delamination.

According to various embodiments, cementitious composite 10 includes a different combination of layers. By way of example, cementitious composite 10 may include impermeable layer 50, structure layer 40, adhesive layer 60, cementitious mixture 30, and/or permeable layer 20. Such a composite may utilize the structure layer 40 and/or the adhesive layer 60 to hold cementitious mixture 30, may include a removable layer to retain cementitious mixture 30 during transport and in the application of cementitious composite 10, and/or may include another system designed to retain cementitious mixture 30. According to various alternative embodiments, cementitious composite 10 includes permeable layer 20 and impermeable layer 50, only impermeable layer 50, only permeable layer 20, or neither permeable layer 20 nor impermeable layer 50. By way of example, cementitious composite 10 may include impermeable layer 50, structure layer 40, adhesive layer 60, cementitious mixture 30, and permeable layer 20. By way of another example, cementitious composite 10 may include impermeable layer 50, structure layer 40, adhesive layer 60, and cementitious mixture 30. By way of yet another example, cementitious composite 10 may include impermeable layer 50, adhesive layer 60, cementitious mixture 30, and permeable layer 20. By way of still another example, the cementitious composite 10 may include impermeable layer 50 and adhesive layer 60, and cementitious mixture 30 may be introduced thereon on-site (e.g., cementitious mixture 30 may be scattered, laid, embedded, etc. across, in, and/or along impermeable layer 50 on-site and prior to in-situ hydration, etc.). Further, impermeable layer 50 may have one or more surface imperfections and/or a roughness (e.g., fibers, members, barbs, etc.) that are configured to facilitate holding cementitious mixture 30 prior to and/or after hydration, attach to the hardened concrete, and/or be embedded within the hardened concrete. By way of still another example, cementitious composite 10 may include only structure layer 40 and cementitious mixture 30 may be introduced therein on-site (e.g., cementitious mixture 30 may be scattered, laid, embedded, etc. across, in, and/or along structure layer 40 on-site and prior to in-situ hydration, etc.). By way of a further example, cementitious composite 10 may include only (i) permeable layer 20 or impermeable layer 50 and (ii) cementitious mixture 30. Cementitious mixture 30 may be introduced on-site (e.g., cementitious mixture 30 may be scattered across or otherwise deposited on the ground, compacted soil, non-compacted soil, cracked concrete substrate in need of repair, another substrate, etc.) and may be compacted on-site. Permeable layer 20 or impermeable layer 50 may be introduced after cementitious mixture is deposited on the ground, substrate, etc. to aid in hydration and reduce washout of cementitious mixture 30 (e.g., for mixes with water absorbent polymers, etc.). By way of a further example, cementitious composite 10 may include only cementitious mixture 30 (e.g., a mixture of constituent materials, etc. in a pre-packaged bagged form, in super sacks, or in portable sacks, etc.). Such a cementitious mixture 30 may be scattered across or otherwise deposited on the ground (e.g., compacted soil, non-compacted soil, cracked concrete substrate in need of repair, another substrate, etc.) on-site without permeable layer 20, structure layer 40, and/or impermeable layer 50. The layer of cementitious mixture 30 may be compacted using hand tools or heavy equipment prior to in-situ hydration.

According to still another alternative embodiment, cementitious composite 10 includes cutout voids extending entirely through cementitious composite 10. By way of example, the cutout voids may allow a fluid to drain through the composite after hardening. A cementitious composite having cutout voids may be produced by forming voids either before or after manufacturing the composite. The cutout voids may be formed in any shape (e.g., triangle, circle, oval, diamond, square, rectangle, octagon, etc.). The volume of the composite removed to form the cutout voids may define between one and ninety percent of the total composite volume.

Referring next to the exemplary embodiment shown in FIG. 3, cementitious composite 10 may be arranged into a flexible sheet. As shown in FIG. 3, permeable layer 20, structure layer 40, and impermeable layer 50 are each flexible and disposed adjacent to one another. According to an exemplary embodiment, such a combination of flexible layers facilitates rolling cementitious composite 10 to facilitate transportation and reduce the amount of cementitious mixture 30 that migrates through permeable layer 20. According to an alternative embodiment, cementitious composite 10 may be arranged in another configuration (e.g., various sheets that may be stacked, a sheet having a pre-formed shape, etc.).

### Structure Layer

Structure layer 40 may include low density, high void space, and discontinuities, among other characteristics. In one embodiment, structure layer 40 is an independent, structural material configured to support the weight of cementitious mixture 30, thereby reducing the risk of pre-hydration delamination (e.g., separation of structure layer 40 from impermeable layer 50, from permeable layer 20, from adhesive layer 60, etc.), while improving the strength of the cementitious composite 10 post-hydration. By way of example, structure layer 40 may be configured to independently support a cementitious mix having a weight of between one and five pounds per square foot. These characteristics improve the strength and transportability, among other features, of cementitious composite 10. Structure layer 40 may also reduce the prevalence and/or severity of shrink-induced cracking within cementitious mixture 30. Such a reduction may be produced because structure layer 40 limits crack propagation by bridging crack faces within the cementitious phase.

According to an exemplary embodiment, structure layer 40 is flexible. In other embodiments, structure layer 40 is semi-rigid. By way of example, structure layer 40 may have a predefined shape (e.g., curved, etc.) such that cementitious composite 10 takes the shape of structure layer 40. In some embodiments, structure layer 40 is deformable (e.g., plastically deformable, etc.). According to an exemplary embodiment, structure layer 40 includes at least one of a natural material (e.g., coconut fiber, cellulose fiber, other natural materials, etc.), a synthetic material (e.g., aramid glass, etc.), a polymeric material, (e.g., plastic, nylon, polypropylene, etc.), a metallic material (e.g., metal, aluminum oxide, etc.), and a composite material (e.g., carbon fiber, silicon carbide, etc.).

According to an exemplary embodiment, structure layer 40 may have independent mechanical properties apart from those of the other layers of cementitious composite 10. By way of example, such mechanical properties may include tensile strength, elongation at break, and tear strength, among other known properties. Structure layer 40 may have portions with a target thickness, length, and/or coupling designed to provide target mechanical properties. Structure layer 40 may have a composition that provides a target mechanical property. The modulus of elasticity and geometry of structure layer 40 may affect the flexibility of cementitious composite 10. A structure layer 40 having one of a lower modulus of elasticity or more open geometry may increase the pliability (e.g., lower radius of curvature, etc.) of cementitious composite 10 (e.g., for shipping, to contain cementitious mixture 30, etc.).

According to an alternative embodiment, structure layer 40 includes void patterns (e.g., shapes cut through structure layer 40, three dimensional voids formed within structure layer 40, etc.). Such void patterns may be formed in structure layer 40 through cutting, forming, or another process. The void patterns may be formed during the primary manufacturing of structure layer 40 or subsequently as a secondary manufacturing process. According to an exemplary embodiment, the void patterns are randomly distributed or formed in sequence (e.g., a honeycomb, etc.). The void patterns may decrease the time required to dispose cementitious mixture 30 in structure layer 40, improve the physical properties of cementitious composite 10 after in-situ hydration, and/or provide other advantages.

According to an alternative embodiment, a coating may be disposed around and/or along at least a portion of structure layer 40. By way of example, the coating may be configured to improve various properties (e.g., strength, durability, etc.) of structure layer 40. As still a further example, the coating may improve the coupling strength of portions within structure layer 40, of structure layer 40 to permeable layer 20, impermeable layer 50, and/or adhesive layer 60, and of structure layer 40 to cementitious mixture 30 after in-situ hydration. By way of example, the coating may include an abrasive coating (e.g., similar to that provided with a Scotch-Brite® scouring pad, etc.), a coating to provide resistance to ultraviolet light, a coating to protect structure layer 40 from cementitious mixture 30 (e.g., improved alkaline resistance, improved bonding to cementitious mixture 30 post-hydration, to reduce delamination and/or detachment from set cementitious mixture 30, etc.), and/or still another known coating.

In some embodiments, cementitious composite 10 includes a scrim lining (e.g., a mesh reinforcing material, a grid reinforcing material, a geotextile, a geogrid, a nonwoven material, a woven material, etc.) coupled to (e.g., fused, integrally formed, joined, etc.) structure layer 40. A scrim lining may be coupled to one or more surfaces of structure layer 40 or disposed within structure layer 40. By way of example, the scrim lining may be disposed along a top surface (e.g., the topmost, etc.) of structure layer 40, disposed along a bottom surface (e.g., the bottommost, etc.) of structure layer 40, disposed within a middle portion of structure layer 40, disposed along an edge of structure layer 40, extending diagonally within structure layer 40, etc. The scrim lining may be a similar material as permeable layer 20 to improve bonding between permeable layer 20 and structure layer 40 (e.g., when the scrim is disposed along the bonding interface, etc.). The scrim lining may improve the tensile strength of structure layer 40 and cementitious composite 10 both before and after in-situ hydration. By way of example, a loosely assembled structure layer 40 may have a tendency to separate, and a scrim lining may reinforce structure layer 40 to prevent such separation. The scrim lining may decrease the risk of delamination of permeable layer 20 and/or impermeable layer 50 therefrom (e.g., when the scrim lining is positioned on the top and/or the bottom of structure layer 40, etc.).

According to various exemplary embodiments, structure layer 40 may include one or more of: a bunching layer, a mesh layer, a grid layer, a nonwoven layer, a not woven layer, a nonfibrous layer, a fiberless layer, pins and/or connectors, an interconnecting particle layer, a coiled layer, a tube layer, a 3D knitted and/or woven layer, a plastic layer, a metal layer, and/or a layer configured for integration with one or more snap-fit connections. Further details regarding structure layer 40 may be found in International Patent Application No. PCT/US2016/060684, filed on Nov. 4, 2016, which is incorporated by reference herein in its entirety.

### Cementitious Mixture

Cementitious Mixture with Absorbent Material

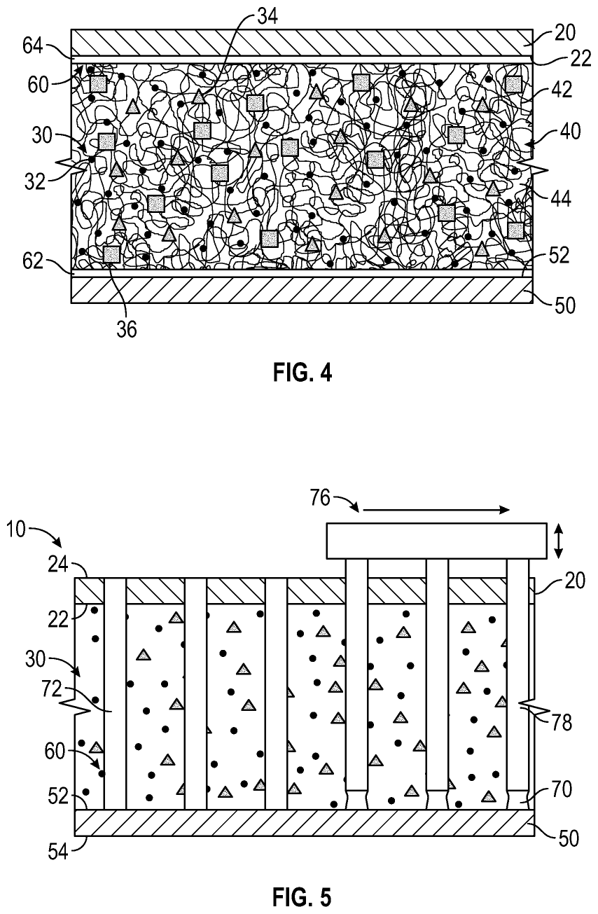

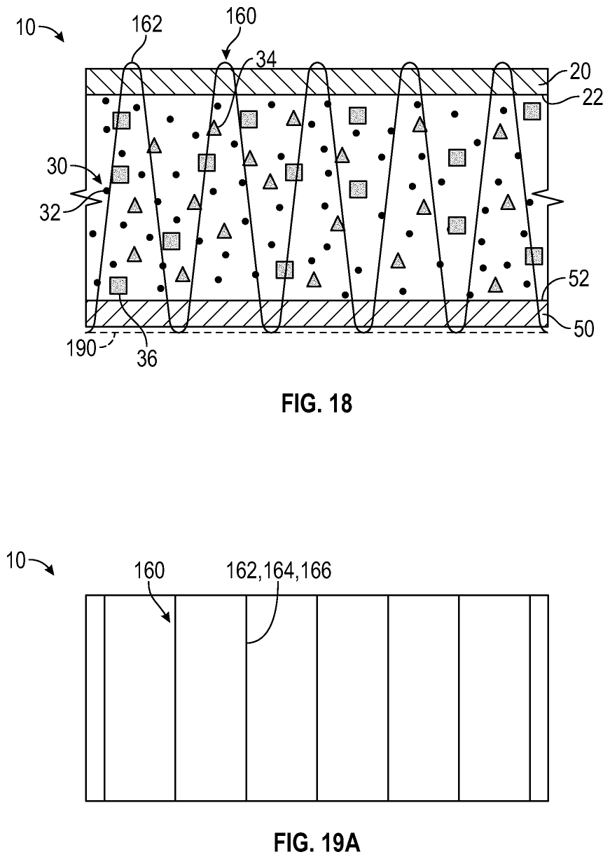

According to the exemplary embodiment shown in FIGS. 4-12, 14A, 14B, and 20B, cementitious mixture 30 is disposed within at least a portion of voids 44 of structure layer 40 and/or adhesive layer 60. According to the exemplary embodiment shown in FIGS. 5-8, 10-12, 17, 18, and 20C, cementitious composite 10 does not include structure layer 40 such that cementitious mixture 30 is disposed between permeable layer 20 and impermeable layer 50 without structure layer 40. In some embodiments, an adhesive (e.g., a liquid adhesive, a gel adhesive, etc.) is mixed with other constituents of cementitious mixture 30. By way of example, the adhesive may facilitate forming (as part of cementitious mixture 30) a tacky layer to which impermeable layer 50 and/or permeable layer 20 may be attached. The tacky layer may be between one tenth and four inches thick. Impermeable layer 50 and/or permeable layer 20 may be coupled along top and/or bottom sides of cementitious mixture 30 with the adhesive. In one embodiment, the adhesive is water permeable. In other embodiments, the adhesive is removed (e.g., heated off, etc.) and/or cured to facilitate hydration of the cementitious particles of cementitious mixture 30 before or after impermeable layer 50 and/or permeable layer 20 are attached. By way of example, 50, 80, or 95 percent (e.g., by area, by volume, by weight, etc.) of the adhesive may be removed and/or cured to facilitate hydration.

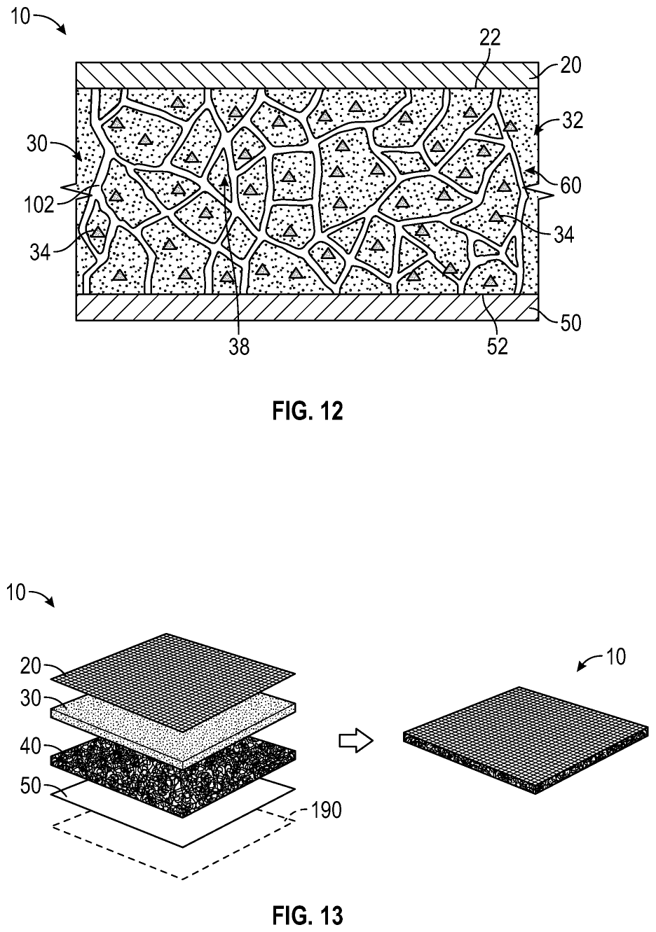

As shown in FIGS. 4, 11, 12, 14A, 14B, and 20B, cementitious mixture 30 includes a mixture of constituents (e.g., materials, etc.), shown as cementitious materials 32. Cementitious materials 32 may include cement (e.g., Portland cement, Alumina cement, CSA cement, etc.) and/or supplementary cementitious materials (e.g., fly ash, silica fume, slag, metakaolin, other supplementary materials, etc.). Cementitious mixture 30 may further include aggregate materials or other filler particles (e.g., fine aggregates, coarse aggregates, sand, limestone, non-absorbent materials, etc.), shown as aggregates 34. In one embodiment, aggregates 34 are uniformly (e.g., evenly, etc.) distributed throughout cementitious mixture 30. In other embodiments, aggregates 34 are non-uniformly (e.g., randomly, unevenly, etc.) distributed throughout cementitious mixture 30. Aggregates 34 may have sizes between greater than thirty mesh (i.e., 595 microns) and less than five mesh (i.e., 4000 microns). In some embodiments, aggregates 34 have sizes between three-hundred mesh (i.e., 50 microns) and thirty mesh. The size of aggregates 34 may be selected to create a desired size and amount of void space within cementitious mixture 30. The size and amount of void space within cementitious mixture 30 may directly affect water flow during in-situ hydration of cementitious composite 10. According to an exemplary embodiment, the sizes of aggregates 34 and amount of compaction of cementitious mixture 30 are selected to create a desired size and/or amount of void space, shown as voids 38, within cementitious mixture 30. The size and amount of voids 38 within cementitious mixture 30 may directly affect water flow during in-situ hydration of cementitious composite 10. The size and amount of voids 38 may additionally or alternatively directly impact the shape of an interconnected adhesive layer (see FIGS. 11 and 12) of cementitious composite 10.

In some embodiments, cementitious mixture 30 includes additives (e.g., fibers, plasticizers, accelerators, retarders, viscosity modifiers, absorbers, water reducers, etc.). Such additives may be used to improve the mechanical properties (e.g., strength, setting time, curing requirements, thermal coefficient of expansion, permeability, acid resistance, etc.) or durability, among other characteristics, of the cementitious mixture 30 and/or may be used as a substitute for a portion of cementitious materials 32. According to an exemplary embodiment, the additives include a pozzolonic material (e.g., fly ash, bottom ash, silica fume, slag, metakaolin, etc.) added at a specified mix ratio.

As shown in FIGS. 4, 14A, 14B, 18, 20B, and 20C, cementitious mixture 30 includes an absorbent material, shown as absorbent material 36. According to an exemplary embodiment, absorbent material 36 is configured to absorb water and expand during in-situ hydration to lock cementitious materials 32 and/or aggregates 34 in place (e.g., increases the stability and/or viscosity of cementitious mixture 30 within structure layer 40, adhesive layer 60, etc.) to prevent washout of cementitious mixture 30 from cementitious composite 10 during hydration. Absorbent material 36 may thereby facilitate applying and topically hydrating cementitious composite 10 on slopes (e.g., hillsides, ditches, etc.) without the risk of washing out cementitious mixture 30 from the structure layer during hydration. Absorbent material 36 may additionally or alternatively improve curing of cementitious composite 10 by providing or releasing water from within cementitious mixture 30 during the curing process. Improving the curing of cementitious composite 10 may improve (e.g., increase, maximize, etc.) the strength thereof (e.g., up to double that of a cementitious composite having a mix that does not include absorbent material, etc.). Absorbent material 36 may additionally or alternatively improve one or more post-hydration and post-cure properties of cementitious composite 10 (e.g., abrasion resistance, flexural strength, puncture strength, compressive strength, etc.). Absorbent material 36 may additionally or alternatively hold water to reduce evaporation, release water over a period of time, and/or control the water to cement ratio.

According to an exemplary embodiment, cementitious mixture 30 includes approximately 0.001-5% (e.g., by weight, by volume, etc. of cementitious mixture 30) of absorbent material 36. Absorbent material 36 may include particles, pellets, powder, fiber, a membrane, microbeads, etc. In some embodiments, absorbent material 36 includes an absorbent material configured to absorb between 0.001 and 1 times its weight in water. In some embodiments, absorbent material 36 includes a superabsorbent material configured to absorb between 1 and 1000 times its weight in water. In one embodiment, the superabsorbent material is configured to absorb between 75 and 300 times its weight in water, for example approximately 200 times its weight in water. The superabsorbent material may include a superabsorbent polymer (SAP). The SAP may include sodium polyacrylate, poly-acrylic acid sodium salt, polyacrylamide copolymer, ethylenemaleic anhydride copolymer, cross-linked carboxymethylcellulose, polyvinyl alcohol copolymers, cross-linked polyethylene oxide, and/or starch grafted copolymer of polyacrylonitrile, among other possible SAPs. The superabsorbent material may additionally or alternatively include a superabsorbent clay (e.g., to form a SAP composite (SAPC), etc.). The superabsorbent clay may include montmorillonite and/or other substances used to create a SAPC.

According to an exemplary embodiment, absorbent material 36 has a particle size that may range from 1 micron to 5000 microns. In one embodiment, the majority of absorbent material 36 has a particle size between 90 microns and 300 microns at a specified mix ratio. By way of example, the specified mix ratio of absorbent material 36 may include 0-30% of particles having a size less than 90 microns (e.g., approximately 7%, etc.), 10-60% of particles having a size between 90-150 microns (e.g., approximately 37%, etc.), 25-80% of particles having a size between 150-300 microns (e.g., approximately 56%, etc.), and 0-30% of particles having a size greater than 300 microns (e.g., approximately 0%, etc.). Applicant has discovered that larger particles of absorbent material 36 (e.g., particles having a size greater than 150 microns, etc.) provide improved washout resistance relative to smaller particles of absorbent material 36 (e.g., particles less than 150 microns, etc.). By way of example, the larger particles may absorb water more quickly and form a gel-like substance during and/or post-hydration that locks cementitious materials 32 and aggregates 34 within structure layer 40 and/or adhesive layer 60 of cementitious composite 10 to prevent washout thereof. Quicker absorption of water may be advantageous as cementitious composite 10 may be topically hydrated quickly, on a slope, and/or at a relatively high pressure. Applicant has also discovered that the smaller particles of absorbent material 36 improve the curing process of cementitious composite 10 (e.g., increasing the strength thereof, etc.). Applicant has also discovered that smaller particles create a finer, less abrasive material after hydration with lower permeability.

In some embodiments, cementitious mixture 30 includes lime (e.g., hydrated lime, etc.). By way of example, cementitious mixture 30 may include absorbent material 36, lime, or both absorbent material 36 and lime. Applicant has discovered that lime stiffens and sets quickly (e.g., almost instantaneously with the proper mix ratios of lime) relative to one or more other constituents of cementitious mixture 30. Applicant has further discovered that the quick-setting lime locks one or more of the other constituents of cementitious mixture 30 in place, thereby reducing washout of cementitious mixture 30 during hydration. According to an exemplary embodiment, cementitious mixture 30 includes approximately 0.01 to greater than 30% (e.g., by weight of cementitious mixture 30) of lime. In one embodiment, cementitious mixture 30 includes approximately 2-5% (e.g., by weight of cementitious mixture 30) of lime.

In some embodiments (e.g., embodiments in which cementitious mixture includes lime, etc.), cementitious mixture 30 includes fibers (e.g., fine fibers, etc.). In other embodiments, fibers may be used in combination with the absorbent material 36 in cementitious mixture 30 without the addition of lime. The fibers may advantageously reduce cracking of cementitious composite 10. According to an exemplary embodiment, cementitious mixture 30 includes fibers having sizes between 0.05 millimeters (mm) and 20 mm. Applicant has discovered that fibers sized less than 1 mm have the greatest impact on crack prevention. According to an exemplary embodiment, cementitious mixture 30 includes approximately 0.05-2.5% (e.g., by weight of cementitious mixture 30) of fibers. In other embodiments, cementitious mixture 30 has a greater or lesser amount of fibers. The fibers may be manufactured from a synthetic material (e.g., polypropylene, polyethylene, nylon, glass, polyester, acrylic, aramid, etc.) and/or natural material (e.g., cellulose fiber, coconut fiber, grass, etc.). The fibers may be a monofilament, fibrillated, and/or have another structure. According to an exemplary embodiment, cementitious mixture 30 having lime, fibers, and/or absorbent material 36 provides improved performance of cementitious composite 10 in terms of increased washout prevention, decreased cracking, improved curing, increased strength (e.g., ultimate strength, flexural strength, puncture strength, compressive strength, etc.), etc.

According to an exemplary embodiment, the materials of cementitious mixture 30 are mixed together and thereafter disposed along or between impermeable layer 50, adhesive layer 60, and/or permeable layer 20. In one embodiment, cementitious mixture 30 is positioned within voids 44 of structure layer 40 and/or adhesive layer 60 using gravity, vibration, and/or compaction. According to an exemplary embodiment, cementitious material 32, aggregates 34, and/or absorbent material 36 of cementitious mixture 30 substantially fill voids 44. Cementitious mixture 30 may be disposed into structure layer 40 and/or adhesive layer 60, and along impermeable layer 50 with a uniform thickness (e.g., 0.25″, 0.5″, 0.75″, etc.). In some embodiments, permeable layer 20 is disposed along cementitious mixture 30 before compaction such that cementitious mixture 30 is compressed between permeable layer 20 and impermeable layer 50. The compression may be applied to facilitate even distribution of the constituents (e.g., absorbent material 36, aggregates 34, cementitious materials 32, additives, etc.) within cementitious mixture 30 and/or affect the sizing of the void space within cementitious mixture 30. Compaction may be facilitated or replaced with vibration. The compression may also increase the structural performance of the cementitious mixture 30 post-hydration. The extent that cementitious mixture 30 is compacted may impact the risk of cementitious mixture 30 washing out from cementitious composite 10 (e.g., reduce the risk of washout, etc.), the ability of water to flow through cementitious mixture 30, the time required for hydration, setting, and hardening of cementitious mixture 30, the strength of cementitious composite 10, and/or the risk of cementitious materials 32, aggregates 34, and/or absorbent materials 36 migrating out of cementitious composite 10. In some embodiments, an absorbent material (e.g., absorbent material 36, etc.) is additionally or alternatively coupled to, sprayed onto, bonded to, and/or otherwise attached to (e.g., integrally formed with, etc.) permeable layer 20, structure layer 40, adhesive layer 60, and/or impermeable layer 50. The absorbent material may improve (e.g., further improve, etc.) curing of cementitious mixture 30.

According to an exemplary embodiment, cementitious mixture 30 includes materials (e.g., cementitious materials 32, etc.) that set and harden once exposed to a fluid (e.g., water, etc.) through a hydration process. According to an exemplary embodiment, cementitious mixture 30 is disposed and/or compressed between permeable layer 20 and impermeable layer 50, and undergoes a normal setting and hardening process after in-situ hydration. The setting process may begin once cementitious mixture 30 interacts with a fluid (e.g., water, etc.). Such hydration and setting processes change cementitious mixture 30 from a flexible to a rigid material. While setting produces a rigid material, curing may improve the strength of cementitious composite 10. According to an exemplary embodiment, cementitious mixture 30 has a compressive strength of up to ten thousand or more pounds per square inch. According to an alternative embodiment, cementitious mixture 30 is modified with high performance cementitious ingredients and additives to achieve strength values in excess of ten thousand pounds per square inch.

According to an exemplary embodiment, water is added to cementitious mixture 30 to initiate the hydration processes. An operator may topically apply water to the surface of cementitious composite 10 in-situ to hydrate cementitious mixture 30. In some embodiments, cementitious composite 10 accommodates hydration even when positioned on a horizontal, positioned at an angle, or positioned over a curved surface without undermining the strength of cementitious composite 10. According to an exemplary embodiment, cementitious composite 10 may be hydrated even if positioned at up to a 90 degree angle relative to level. In these or other embodiments, cementitious mixture 30 may set without segregating from cementitious composite 10. In embodiments where permeable layer 20 does not dissolve quickly, cementitious composite 10 may be hydrated in an inverted position. By way of example, cementitious composite 10 may be implemented in a tunnel application where the cementitious composite 10 is used to form the walls and/or ceiling of the tunnel.

The characteristics of the hydrated cementitious composite 10 may be affected by at least one of (i) the particle size of absorbent material 36, aggregates 34, and/or cementitious materials 32 of cementitious mixture 30, (ii) the characteristics of adhesive layer 60 (e.g., structure, type, etc.), and (iii) the size, shape, diameter, material composition, pattern, and/or structure (e.g., bunching, nonwoven, not woven, grid, interconnecting particles, connectors, etc.) of structure layer 40. By way of example, particle size and density may affect the homogeneity of cementitious mixture 30 thereby impacting various properties (e.g., strength, flexibility, etc.) of cementitious composite 10. According to an exemplary embodiment, cementitious materials 32 of cementitious mixture 30 have an approximately equal particle size (e.g., within 150 microns, etc.). According to an alternative embodiment, cementitious materials 32 of cementitious mixture 30 may have different sizes (e.g., a variation of more than 150 microns, etc.) that vary between 0.5 and 450 microns. A cementitious mixture 30 having differentially-sized particles may improve packing and reduce open space within cementitious mixture 30, as well as substantially fill voids 44 of structure layer 40.

According to an exemplary embodiment, cementitious mixture 30 is cured using an external curing process. By way of example, such external curing may include water ponding. According to various alternative embodiments, the external curing process includes water spraying, wet burlap, sheeting, curing compounds, absorbent sands, and accelerated curing, among other known methods. In some embodiments, permeable layer 20 is formed of a hydrophilic material (e.g., paper, cellulose based materials, etc.) that may improve curing by holding water to prolong exposure of cementitious mixture 30 to a fluid. In some embodiments, permeable layer 20 includes a water soluble material which holds water and only dissolves with warm or hot water (e.g., greater than 70, 80, 90, 100, 110, 120, 130, etc. degrees Fahrenheit, etc.). Such a permeable layer 20 may thereby hold water for a desired period of time while hydrating cementitious mixture 30 and may thereafter be removed (e.g., disintegrated, detached, etc.) using warm or hot water. According to an alternative embodiment, permeable layer 20 is formed of a coating material having fewer apertures to improve curing by reducing the evaporation of water from cementitious mixture 30.

According to still another alternative embodiment, cementitious mixture 30 is cured using an internal curing process. According to an exemplary embodiment, cementitious mixture 30 is cured using internal water curing where cementitious mixture 30 includes a component that serves as a curing agent to the cementitious mixture. Such a component may include either absorbent material 36, an aggregate, or a new component (e.g. an additive, superabsorbent polymer, special aggregate, etc.) introduced into cementitious mixture 30 during the manufacturing process. Further, hydrophilic additives (e.g., absorbent material 36, superabsorbent polymers, etc.) may improve curing by facilitating the ingress of water within cementitious mixture 30. According to an alternative embodiment, structure layer 40 and/or adhesive layer 60 are hydrophilic (e.g., absorbent, etc.) and facilitate the absorption of water into cementitious mixture 30.

In some embodiments, cementitious mixture 30 includes interconnection particles (e.g., beads, pellets, strands, etc.; made of a resin, a polymer, elastomeric polymer, PVC, polypropylene, polyethylene, a metal or metal alloy having a low melting point, etc.) that form an interconnected layer, i.e., similar to structure layer 40, after activation (e.g., heating, etc.). The interconnected layer may reinforce the cementitious mixture 30 post-hydration, reducing crack propagation and improving the strength of the cementitious composite 10. The interconnection particles may be configured to melt, fuse, or otherwise deform (e.g., expand, etc.) in response to activation. By way of example, the interaction particles may melt during an application of heat to cementitious composite 10 (i.e., a heat treatment process) with an activation system (e.g., a heating system, etc.). The activation may cause the interaction particles (e.g., in proximity to one another before activation, etc.) to fuse or otherwise join together at bonding locations. The interconnection particles may melt, expand, or otherwise change shape to form structure layer 40 (e.g., a web, a nonwoven layer, a not woven layer, an interconnected layer, etc.). Structure layer 40 may have structural strands post-activation (e.g., upon cooling, etc.). Heating systems may provide thermal energy to cementitious composite 10 (e.g., directly or indirectly to cementitious mixture 30, permeable layer 20, impermeable layer 50, etc.) to increase the temperature of cementitious composite 10 or portions thereof above the melting point of the interconnecting particles such that the interconnecting particles melt and/or expand to form structure layer 40.

Cementitious Mixture with Interconnection Particles

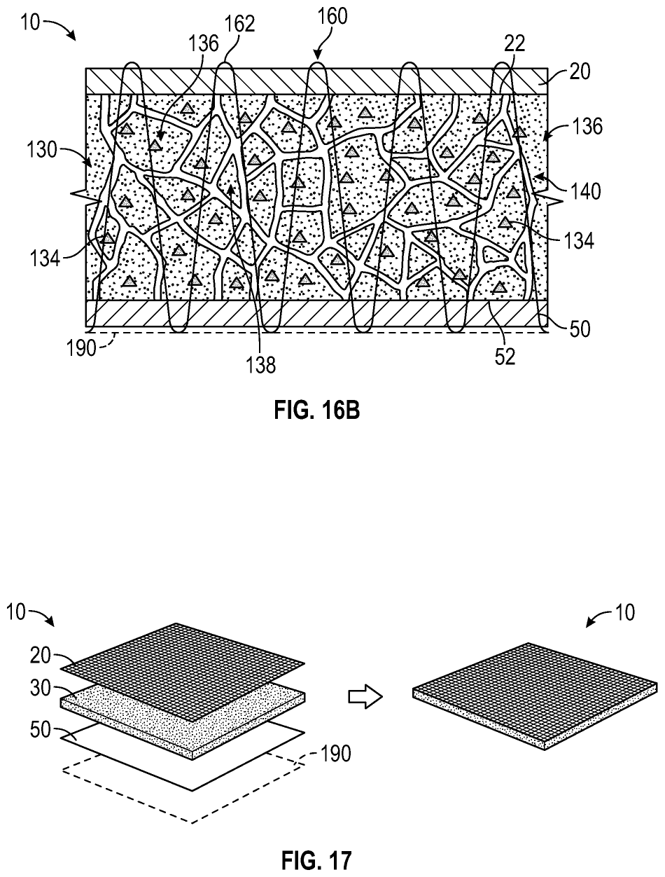

In some embodiments, cementitious composite 10 additionally or alternatively includes a second cementitious mixture. According to the exemplary embodiment shown in FIGS. 16A and 16B, cementitious composite 10 includes a second cementitious mixture, shown as cementitious mixture 130. According to an exemplary embodiment, cementitious mixture 130 eliminates the need for a structure layer (e.g., structure layer 40, etc.). However, cementitious mixture 130 may be used in combination with a structure layer (e.g., structure layer 40, etc.). As shown in FIGS. 16A and 16B, cementitious mixture 130 includes a mixture of constituents (e.g., materials, etc.), shown as cementitious materials 136. Cementitious materials 136 may include cement (e.g., Portland cement, etc.) and/or supplementary cementitious materials (e.g., fly ash, silica fume, slag, metakaolin, etc.). Cementitious mixture 130 includes interconnection particles, shown as beads 132, that form an interconnected layer after activation. In some embodiments, cementitious mixture 30 includes beads 132. The interconnected layer reinforces the cementitious mixture 130 post-hydration, reducing crack propagation and improving the strength of the cementitious composite 10. In one embodiment, beads 132 are uniformly (e.g., evenly, etc.) distributed throughout cementitious mixture 130. In other embodiments, beads 132 are non-uniformly (e.g., randomly, unevenly, etc.) distributed throughout cementitious mixture 130. In one embodiment, cementitious mixture 130 includes between five and twenty percent beads 132 by weight. In other embodiments, cementitious mixture 130 includes more than twenty percent beads 132 by weight. According to an exemplary embodiment, beads 132 have a size between one and four hundred microns. In other embodiments, beads 132 have a size greater than 400 microns. According to an exemplary embodiment, beads 132 include a polymeric material (e.g., a resin, a polymer, elastomeric polymer, PVC, polypropylene, polyethylene, etc.). In other embodiments, beads 132 include a metal (e.g., a metal or metal alloy having a low melting point, etc.). In one embodiment, beads 132 are spherical in shape. In other embodiments, beads 132 have a fibrous shape and may have a length between one-hundredth of a millimeter and twenty millimeters. Beads 132 having a fibrous shape may have multiple fiber extensions extending from a main body of each bead 132. In still other embodiments, beads 132 are still otherwise shaped (e.g., cylindrical, pellet-shaped, square, ellipsoidal, pill-shaped, etc.).

As shown in FIGS. 16A and 16B, cementitious mixture 130 includes aggregate materials or other filler particles or additives (e.g., fine aggregates, coarse aggregates, sand, limestone, shrinking additives, disintegrating additives, porous additives, heat-sensitive products, etc.), shown as aggregates 134. In one embodiment, aggregates 134 are uniformly (e.g., evenly, etc.) distributed throughout cementitious mixture 130. In other embodiments, aggregates 134 are non-uniformly (e.g., randomly, unevenly, etc.) distributed throughout cementitious mixture 130. Aggregates 134 may have varying sizes ranging from less than thirty mesh (i.e., 595 microns) to greater than five mesh (i.e., 4000 microns). The size and shape of void space within cementitious mixture 130 may be related to the size and shape of the constituents thereof. According to an exemplary embodiment, the sizes of aggregates 134 are selected to create a desired size and/or amount of void space, shown as voids 138, within cementitious mixture 130. The size and amount of voids 138 within cementitious mixture 130 may directly affect water flow during in-situ hydration of cementitious composite 10. The size and amount of voids 138 may additionally or alternatively directly impact the shape of the interconnected layer formed by beads 132.

In some embodiments, cementitious mixture 130 includes additives (e.g., fibers, plasticizers, accelerators, retarders, super absorbent polymers, viscosity modifiers, etc.). Such additives may be used to improve the mechanical properties (e.g., strength, setting time, curing requirements, thermal coefficient of expansion, etc.) or durability, among other characteristics, of the cementitious mixture 130 or may be used as a substitute for a portion of cementitious materials 136. According to an exemplary embodiment, the additive includes a pozzolonic material (e.g., fly ash, bottom ash, silica fume, slag, metakaolin, etc.) added at a specified mix ratio.

According to an exemplary embodiment, the mixture of materials of cementitious mixture 130 is mixed together and thereafter disposed along or between impermeable layer 50 and/or permeable layer 20. In one embodiment, cementitious mixture 130 is disposed along impermeable layer 50 with a uniform thickness (e.g., 0.25″, 0.5″, 0.75″, etc.). In some embodiments, cementitious mixture 130 is compressed onto impermeable layer 50. In other embodiments, permeable layer 20 is disposed along cementitious mixture 130 before compaction such that cementitious mixture 130 is compressed between permeable layer 20 and impermeable layer 50. The compression may be applied to facilitate even distribution of the constituents (e.g., beads 132, aggregates 134, cementitious materials 136, additives, etc.) within cementitious mixture 130 and/or vary the size and/or shape of voids 138 within cementitious mixture 130. Compression may be facilitated or replaced with vibration. The compression may also increase the structural performance of the cementitious mixture 130 post-hydration. The extent that cementitious mixture 130 is compacted may impact the ability of water to flow through cementitious mixture 130, the time required for hydration, setting, and hardening of cementitious mixture 130, the strength of cementitious composite 10, and/or the risk of cementitious mixture 130 migrating through permeable layer 20.

As shown in FIGS. 16A and 16B, beads 132 are configured to melt, fuse, or otherwise deform (e.g., expand, etc.) in response to activation. By way of example, beads 132 may melt during an application of heat to cementitious composite 10 (i.e., a heat treatment process) with an activation system (e.g., a heating system, etc.). By way of another example, beads 132 may expand during an application of heat in one or more directions. Beads 132 may be oriented a certain way such that the expansion thereof creates a target final structure (e.g., expanded portions of beads 132 may protrude into adjacent voids and/or openings within cementitious mixture 130, etc.). As shown in FIG. 16B, the activation causes beads 132 (e.g., beads 132 in proximity to one another before activation, etc.) to fuse or otherwise join together at bonding locations or interconnection points. Beads 132 may melt, expand, or otherwise change shape to form a structural layer (e.g., a web; an interconnected layer; a nonwoven, not woven, fiberless, nonfibrous, etc. layer), shown as interconnecting structure 140. Interconnecting structure 140 has structural strandspost-activation (e.g., upon cooling, etc.). The activation systems may provide thermal energy to cementitious composite 10 (e.g., directly or indirectly to cementitious mixture 130, permeable layer 20, impermeable layer 50, etc.) to increase the temperature of cementitious composite 10 or portions thereof above the melting point of beads 132 such that beads 132 melt and/or expand to form interconnecting structure 140. In one embodiment, the melting point of beads 132 is between three hundred and five hundred degrees Fahrenheit. In other embodiments, the melting point of beads 132 is less than three hundred degrees Fahrenheit or more than five hundred degrees Fahrenheit. In still another embodiment, the material of beads 132 is selected to have a melting point of less than or equal to the melting point of permeable layer 20 and/or impermeable layer 50.

The strands of interconnecting structure 140 may have varying densities throughout cementitious mixture 130 (e.g., based on the number of beads 132 in a given area of cementitious mixture 130, etc.). The thickness, density, shape, and/or quality of the strands may be related to the shape and size of voids 138, which are themselves related to at least the amount and size of aggregates 134 and the compressive force applied to cementitious composite 10. According to an exemplary embodiment, larger aggregates 134 are included within cementitious mixture 130 to create larger voids 138 to facilitate greater movement of the melted or expanding beads 132 within cementitious mixture 130 when forming interconnecting structure 140.

In some embodiments, aggregates 134 are reactive to heat such that aggregates 134 disintegrate and/or shrink to create channels (e.g., expand voids 138, etc.) within cementitious mixture 130 during an activation process (e.g., heating process, etc.). The channels within cementitious mixture 130 may provide a passage for beads 132, post-activation, to melt, expand, and/or otherwise deform to form interconnecting structure 140. Aggregates 134 may include a heat sensitive and/or reactive material that heats and/or otherwise burns at a relatively low temperature (e.g., relative to beads 132, permeable layer 20, impermeable layer 50, etc.; 150, 180, 200, 250, 300, etc. degrees Fahrenheit; etc.). By way of example, aggregates 134 may have a first size (e.g., a pre-activation size, etc.). The size of voids 138 between aggregates 134 pre-activation may relate to the selected size of aggregates 134, the compressive force applied to cementitious mixture 130, and/or the quantity of aggregates 134 relative to beads 132 and/or cementitious materials 136. The aggregates 134 may have a second size (e.g., a post-activation size, etc.) after an activation process (e.g., a heating process, etc.). The size of voids 138 between aggregates 134 post-activation may relate to the selected size of aggregates 134, a designed shrinkage amount of aggregates 134, the compressive force applied to cementitious mixture 130, and/or the quantity of aggregates 134 relative to beads 132 and/or cementitious materials 136. Such reactive aggregates may have a designed shrinkage amount resulting from activation that facilitates increased flow (or expansion) of the activated beads 132 within voids 138. The designed shrinkage amount of aggregates 134 may range from 1% to 99% shrinkage (e.g., 20%, 40%, 60%, 90%, etc.) from the initial, first size of aggregates 134. In other embodiments, such reactive aggregates 134 may disintegrate when activated. In some embodiments, beads 132 include an expansive additive such that beads 132 expand when activated (e.g., heated, etc.) to better fill voids 138 of cementitious mixture 130. In some embodiments, cementitious mixture 130 includes additives that are heat conductive (e.g., slag, metal fibers, other fine melts, etc.) to increase heat transfer through the interior of cementitious mixture 130 to melt, expand, or otherwise deform beads 132. In some embodiments, compression is applied to cementitious composite 10 during the application of heat to reduce activation-induced deformation of cementitious composite 10 (e.g., due to thermal expansion, etc.). In some embodiments, compression is increased as beads 132 melt, expand, or otherwise deform. Compression may control the expansion of beads 132.

According to an exemplary embodiment, interconnecting structure 140 forms a structure layer that supports (e.g., holds, contains, reinforces, etc.) cementitious mixture 130. By way of example, the strands of interconnecting structure 140 may physically support cementitious mixture 130 (e.g., by filling voids 138, by forming around the constituent particles of cementitious mixture 130, etc.). The size, shape, orientation, and/or quantity of beads 132 that form the strands may be designed to provide target structural properties and/or hydration characteristics of cementitious composite 10. By way of example, fewer voids 138 may produce a greater density of strands and improve the strength of cementitious mixture 130 but make it harder to hydrate.

According to an exemplary embodiment, the strands of interconnecting structure 140 attach to at least one of permeable layer 20 and impermeable layer 50 as a result of activation. By way of example, heat may be applied to cementitious composite 10 when cementitious mixture 130 is disposed on top of impermeable layer 50, and the strands of interconnecting structure 140 attach to impermeable layer 50. By way of another example, heat may be applied to cementitious composite 10 when cementitious mixture 130 is disposed between permeable layer 20 and impermeable layer 50, and the strands of interconnecting structure 140 may form therebetween and attach to permeable layer 20 and impermeable layer 50 (e.g., thereby coupling permeable layer 20 and impermeable layer 50 together, etc.). According to an exemplary embodiment, interconnecting structure 140 is a nonwoven layer such that the formation of interconnecting structure 140 within cementitious mixture 130 creates a nonwoven cementitious composite 10.

As shown in FIG. 16B, the strands of interconnecting structure 140 may attach to inner side 22 of permeable layer 20 and/or inner side 52 of impermeable layer 50 at bonding points. The strands may fuse to or into permeable layer 20 and/or impermeable layer 50. By way of example, at least one of permeable layer 20 and impermeable layer 50 may have a braided, etched, or otherwise roughened surface to receive the material of beads 132 to form the bonding points. In some embodiments, inner side 22 of permeable layer 20 includes fibrous elements extending therefrom. The fibrous elements along inner side 22 of permeable layer 20 may have a density that facilitates increased bonding between permeable layer 20 and the strands of interconnecting structure 140 at the bonding points. In some embodiments, inner side 52 of impermeable layer 50 includes fibrous elements extending therefrom. The fibrous elements along inner side 52 of impermeable layer 50 may have a density that facilitates increased bonding between impermeable layer 50 and the strands of interconnecting structure 140 at the bonding points.

The frequency at which bonding points between the strands and inner side 22 of permeable layer 20 occur, the bonding points between the strands and inner side 52 of impermeable layer 50 occur, and/or the frequency at which interconnection points between proximate strands occur (e.g., the frequency of bonding, etc.) may be related to at least one of the composition of cementitious mixture 130 (e.g., percentage of beads 132, aggregates 134, cementitious materials 136, etc.), the size of aggregates 134, the amount of heat applied to cementitious composite 10, an expansion coefficient of beads 132, and the compressive force applied to cementitious composite 10 prior to and/or during activation, particularly where such factors impact the size and/or shape of voids 138. The frequency of bonding may thereby vary from, for example, ten bonding points per square inch to ten bonding points per one-tenth of a square inch. The thickness of and/or the frequency of bonding of strands to permeable layer 20 and/or impermeable layer 50 maintains a high peel strength (e.g., strength of the bond between strands and permeable layer 20 and/or impermeable layer 50, etc.) such that permeable layer 20 and/or impermeable layer 50 remain attached thereto.

Various heating systems and methods may be used to heat treat cementitious composite 10 to melt, cool, or deform beads 132 to form interconnecting structure 140. Heating systems may include one or more heating and/or cooling elements. In other embodiments, still other systems are used to activate beads 132. The heating system may provide thermal energy to at least one of cementitious mixture 130, a second or outer side of permeable layer 20, and a second or outer side of impermeable layer 50. In one embodiment, the heating system includes a first heating element (e.g., an upper heating element, etc.) and a second heating element (e.g., a lower heating element, etc.). The first heating element may apply heat directly (e.g., via conductive heat transfer, radiative heat transfer, convective heat transfer, etc.) to permeable layer 20 (i.e., and indirectly to cementitious mixture 130 due to conduction) or directly to cementitious mixture 130 (e.g., if permeable layer 20 is omitted or coupled to cementitious mixture 130 following heat treatment, etc.). The second heating element may apply heat directly (e.g., via conductive heat transfer, radiative heat transfer, convective heat transfer, etc.) to impermeable layer 50 (i.e., and indirectly to cementitious mixture 130 due to conduction). In other embodiments, the heating system includes either the first heating element or the second heating element such that either (i) the permeable layer 20 or cementitious mixture 130 is directly heated by the first heating element or (ii) the impermeable layer 50 is directly heated by the second heating element. In an alternative embodiment, the heating system is configured to heat cementitious mixture 130 internally. According to an exemplary embodiment, the heating system is configured to apply heat to cementitious composite 10 for a period of time (e.g., twenty seconds, two minutes, five minutes, etc.) to heat beads 132 above their melting point to thereby form interconnecting structure 140 within cementitious mixture 130 and attach interconnecting structure 140 to at least one of permeable layer 20 and impermeable layer 50. The activation process may be continuous (e.g., a conveyor system, a portion of cementitious composite 10 is heat treated, etc.). In other embodiments, the activation is a discrete process (e.g., an entire length of one or more cementitious composites 10 is heated treated at once; indexed operation where material is fed, stopped to allow a machine to perform an operation, and thereafter again fed; etc.). In some embodiments, two or more of the heat treatment processes are used in combination (e.g., in sequence; heating, compaction, and cooling; etc.). In some embodiments, two or more cementitious composites 10 are attached together with heat, adhesive, mechanically, etc. to create a thicker and/or longer material. In some embodiments, cementitious composite 10 is punctured to facilitate water permeating therethrough.

According to an exemplary embodiment, interconnecting structure 140 is flexible. Permeable layer 20, interconnecting structure 140, and impermeable layer 50 may each be flexible. According to an exemplary embodiment, such a combination of flexible layers facilitates rolling and transporting cementitious composite 10, reducing the amount of cementitious mixture 130 that migrates through permeable layer 20. According to an alternative embodiment, interconnecting structure 140 is semi-rigid (e.g., when beads 132 include a fusible metal, etc.). Thus, cementitious composite 10 may be arranged in another configuration (e.g., various sheets that may be stacked, a sheet having a preformed shape, etc.).

According to an exemplary embodiment, cementitious mixture 130 includes materials (e.g., cementitious materials 136, etc.) that set and harden once exposed to a fluid (e.g., water, etc.) through a hydration process. According to an exemplary embodiment, cementitious mixture 130 is disposed and/or compressed between permeable layer 20 and impermeable layer 50 and undergoes a normal setting and hardening process after in-situ hydration. The setting process may begin once cementitious mixture 130 interacts with a fluid (e.g., water, etc.). Such hydration and setting processes change cementitious mixture 130 from a powder to a solid material. While setting produces a rigid material, curing may improve the strength of cementitious composite 10. According to an exemplary embodiment, cementitious mixture 130 has a compressive strength of up to five thousand pounds per square inch. According to an alternative embodiment, cementitious mixture 130 is modified with high performance cementitious ingredients and additives to achieve strength values in excess of five thousand pounds per square inch.

According to an exemplary embodiment, water is added to cementitious mixture 130 to initiate the hydration processes. An operator may topically apply water to the surface of cementitious composite 10 in-situ to hydrate cementitious mixture 130. In some embodiments, in-situ hydration may occur where cementitious composite 10 is horizontal, positioned at an angle, or positioned over a curved surface without undermining the strength of cementitious composite 10. According to an exemplary embodiment, cementitious composite 10 may be hydrated even if positioned at up to a 90 degree angle relative to level. In these or other embodiments, cementitious mixture 130 may set without separating from cementitious composite 10.

The characteristics of the hydrated cementitious composite 10 may be affected by the particle size of aggregates 134, beads 132 (i.e., interconnecting structure 140), and/or cementitious materials 136 of cementitious mixture 130. By way of example, particle size and density may affect the homogeneity of cementitious mixture 130 thereby impacting various properties (e.g., strength, flexibility, etc.) of cementitious composite 10. According to an exemplary embodiment, cementitious materials 136 of cementitious mixture 130 have an approximately equal particle size (e.g., within 150 microns, etc.). According to an alternative embodiment, cementitious materials 136 of cementitious mixture 130 have different sizes (i.e., a variation of more than 150 microns, etc.) that vary between 0.5 and 450 microns. A cementitious mixture 130 having differentially sized particles may improve packing and minimize open space within cementitious mixture 130.

According to an exemplary embodiment, cementitious mixture 130 is cured using an external curing process. By way of example, such external curing may include water ponding. According to various alternative embodiments, the external curing process includes water spraying, wet burlap, sheeting, curing compounds, curing sprays, absorbent sands, and accelerated curing, among other known methods. According to an alternative embodiment, permeable layer 20 formed of a hydrophilic material (e.g., paper, cellulose based materials, etc.) may improve curing by holding water to prolong exposure of cementitious mixture 130 to a fluid. According to an alternative embodiment, permeable layer 20 formed of a coating material having fewer apertures may improve curing by reducing the evaporation of water from cementitious mixture 130.

According to still another alternative embodiment, cementitious mixture 130 is cured using an internal curing process. According to an exemplary embodiment, cementitious mixture 130 is cured using internal water curing where cementitious mixture 130 includes a component that serves as a curing agent to the cementitious mixture. Such a component may include either an aggregate or a new component (e.g. an additive, super absorbent polymer, special aggregate, etc.) introduced into cementitious mixture 130 during the manufacturing process. Further, hydrophilic additives (e.g., super absorbent polymers, etc.) may improve curing by facilitating the ingress of water within cementitious mixture 130. According to an alternative embodiment, interconnecting structure 140 is hydrophilic (e.g., absorbent, etc.) and facilitates the absorption of water into cementitious mixture 130.

### Adhesive Layer

According to an exemplary embodiment, adhesive layer 60 is applied to couple (e.g., connect, etc.) permeable layer 20 and impermeable layer 50 to cementitious mixture 30, structure layer 40, and/or each other. In some embodiments, adhesive layer 60 is applied to couple permeable layer 20 and impermeable layer 50 together, without adhesively coupling permeable layer 20 and/or impermeable layer 50 to cementitious mixture 30 and/or structure layer 40. In some embodiments, adhesive layer 60 is configured to fully serve the function of structure layer 40 (e.g., replace and provide the benefits of structure layer 40, such that cementitious composite 10 does not need structure layer 40, to connect permeable layer 20 and impermeable layer 50 to cementitious mixture 30 and/or to each other, to hold cementitious composite 10 together when handling, etc.). Adhesive layer 60 may in include various materials including one or more of hot melt, APO/APAO, PUR, polyurethane, other hot melts, animal glue, single component adhesive, multi component adhesive, epoxy, other adhesives, rubbers, silicon adhesives, cyanoacrylate adhesives, Solvent Cements, 3M 94ca, DHM Adhesives 4291, etc. According to an exemplary embodiment, the adhesive of adhesive layer 60 is a non-water based adhesive such that cementitious materials 32 of cementitious mixture 30 are not activated, or are minimally or partially activated, when adhesive layer 60 comes into contact therewith. Aggregates 34 and other larger particles within cementitious mixture 30 (e.g., particles other than cementitious materials 32, sand, other granules, etc.) may be configured to facilitate adhesive bonding.

Adhesive layer 60 may have a permanent bond strength and may have a short open time (e.g., tacky for a predefined period of time when exposed to air; one minute, two minutes, five minutes, ten minutes, etc.) such that the material thereof dries quickly after being deposited (e.g., onto permeable layer 20, onto impermeable layer 50, onto cementitious mixture 30, into cementitious mixture 30, etc.) to hold the various layers of the cementitious composite 10 together and to be able to be rolled quickly thereafter. Heat may be applied to, over, and/or along adhesive layer 60 after application thereof to cementitious composite 10 to accelerate curing and/or hardening. Adhesive layer 60 may dry to a semi-flexible form and thereby be configured to facilitate rolling of cementitious composite 10.

In some embodiments, adhesive layer 60 is applied in a specific pattern (e.g., sheet layer, grid layer, pin layer, etc.). Depending on the pattern, adhesive layer 60 may improve the structural properties of cementitious composite 10, including, by way of example only, improving post cement hardening (e.g., post-hydration structural properties, etc.), increasing plasticity, improving strain hardening, reducing cracking, increasing impact strength, and/or increasing flexural strength, among other improvements. In one embodiment, a first adhesive layer 60 is deposited onto impermeable layer 50, then cementitious mixture 30 is deposited onto the first adhesive layer 60, then a second adhesive layer 60 is deposited onto the top surface of cementitious mixture 30, and finally permeable layer 20 is disposed along the second adhesive layer 60. In some embodiments, structure layer 40 is disposed along the first adhesive layer 60 prior to cementitious mixture 30 being deposited thereon. In another embodiment, adhesive layer 60 is applied through cementitious mixture 30 (e.g., after cementitious mixture 30 is deposited onto impermeable layer 50, with an injector device, etc.) before or after permeable layer 20 is applied.

As shown in FIG. 4, adhesive layer 60 includes a first adhesive layer, shown as lower adhesive layer 62, positioned between inner side 52 of impermeable layer 50 and the bottom side of structure layer 40 and cementitious mixture 30 to couple the bottom side of structure layer 40 and/or cementitious mixture 30 to impermeable layer 50. As shown in FIG. 4, adhesive layer 60 includes a second adhesive layer, shown as upper adhesive layer 64, positioned between inner side 22 of permeable layer 20 and the top side of structure layer 40 and cementitious mixture 30 to couple the top side of structure layer 40 and/or cementitious mixture 30 to permeable layer 20. By way of example, manufacturing cementitious composite 10 of FIG. 4 may include (i) providing impermeable layer 50, (ii) applying lower adhesive layer 62 along impermeable layer 50, (iii) disposing the bottom side of structure layer 40 along lower adhesive layer 62, (iv) depositing cementitious mixture 30 into structure layer 40 and along lower adhesive layer 62, (v) applying second adhesive layer 64 to the top side of structure layer 40 and cementitious mixture 30, and (vi) disposing permeable layer 20 along upper adhesive layer 64. In some embodiments, cementitious composite 10 of FIG. 4 does not include structure layer 40.

By way of example, adhesive layer 60 (e.g., lower adhesive layer 62, upper adhesive layer 64, etc.) may be deposited in a row arrangement, in a grid arrangement, and/or in a sheet arrangement (e.g., along the length and/or the width of cementitious composite 10, etc.). In one embodiment, the rows and/or grid are applied using a flat head nozzle that facilitates applying wide rows. In another embodiment, the rows and/or the grid are applied using another type of nozzle that facilitates applying thinner strands (e.g., having a 0.5 cm, 1 cm, 2 cm, etc. diameter). In other embodiments, the adhesive layers 60 are deposited into different shapes (e.g., diamond, circle, square, swirl, etc. applied through various adhesive application components). By way of another example, adhesive layer 60 (e.g., lower adhesive layer 62, upper adhesive layer 64, etc.) may be sprayed onto cementitious composite 10. In some embodiments, channels are formed to remove adhesive bonds in certain areas, the adhesive is partially deactivated, and/or a portion of the adhesive is removed (e.g., heated off, etc.) in certain areas to expose cementitious mixture 30 to facilitate hydration.

As shown in FIGS. 5-8, an injector, shown as injector 76, may be used to inject and/or pump liquid adhesive 70 of adhesive layer 60 into cementitious composite 10 that cures and/or hardens into connectors 72 that are internally disposed within cementitious mixture 30 and couple impermeable layer 50 to permeable layer 20. As shown in FIG. 5, the injector 76 includes a plurality of injector tubes, shown as injectors 78. The injectors 78 may push aside or core (i.e., remove) one or more layers of cementitious composite 10. Injectors 78 may be configured to pierce through at least one of permeable layer 20 and impermeable layer 50 and deposit liquid adhesive 70 from within cementitious composite 10. As shown in FIG. 5, injectors 78 pierce through permeable layer 20 and not impermeable layer 50. Injectors 78 may inject liquid adhesive 70 from inner side 52 of impermeable layer 50 through permeable layer 20, sealing the holes created by injectors 78. Liquid adhesive 70 may then solidify to form connectors 72. In another embodiment, injectors 78 pierce through impermeable layer 50 and not permeable layer 20. Injectors 78 may inject liquid adhesive 70 from inner side 22 of permeable layer 20 through impermeable layer 50, sealing the holes created by injectors 78. In other embodiments, injectors 78 pierce through both permeable layer 20 and impermeable layer 50. Injectors 78 may inject liquid adhesive 70 from outer side 54 of impermeable layer 50 to outer side 24 of permeable layer 20, sealing the holes created by injectors 78. In other embodiments, the injectors 78 core voids or channels through cementitious composite 10 by removing cementitious mixture 30. The injectors 78 may thereafter pump liquid adhesive 70 into the voids or channels from the exterior of cementitious composite 10.

In some embodiments, cementitious mixture 30 is not filled at 100% packing density. Cementitious mixture 30 having reduced packing density may facilitate adhesive deposition. Cementitious composite 10 may be compressed further with the adhesive application or afterwards. Less densely compacted cementitious mixture 30 may facilitate flowing liquid adhesive 70 through and into spaces within cementitious mixture 30 and/or facilitate pressing injectors 78 into cementitious mixture 30 more easily without deforming the cementitious mixture 30 (e.g., too much, etc.). Alternatively, cementitious mixture 30 is highly compacted and adhesive injectors 78 force cementitious mixture 30 out of the way when liquid adhesive 70 is deposited. Cementitious composite 10 may be re-compacted thereafter.

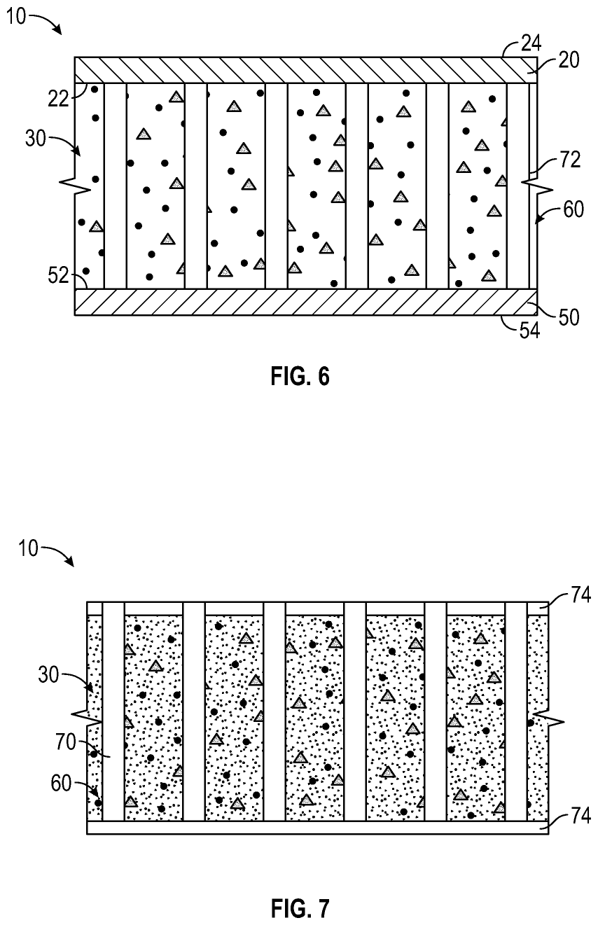

As shown in FIG. 6, permeable layer 20 and impermeable layer 50 are not punctured by injectors 78 to form connectors 72 within cementitious composite 10. By way of example, injectors 78 may inject or pump liquid adhesive 70 into cementitious mixture 30 prior to disposing permeable layer 20 along the top side of cementitious mixture 30. Injectors 78 may deposit a small portion of liquid adhesive 70 onto the top side of cementitious mixture 30 such that small pools of adhesive form. The adhesive may thereafter flow into the gaps and voids of cementitious mixture 30. Permeable layer 20 may thereafter be disposed there along, coupling permeable layer 20 to impermeable layer 50 with connectors 72.

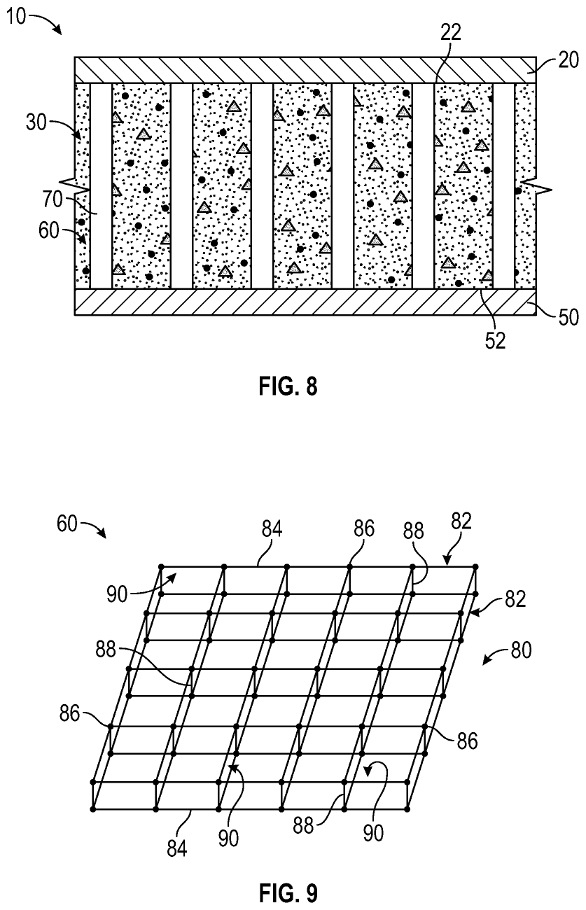

As shown in FIGS. 7 and 8, one or more stabilizing layers, shown as stabilizing layers 74, are provided prior to disposing cementitious mixture 30 between impermeable layer 50 and permeable layer 20. By way of example, stabilizing layers 74 may be applied over cementitious mixture 30 (e.g., either over the top, the bottom, or both of cementitious mixture 30. The injectors 78 may then inject and/or pump liquid adhesive 70 through one or more of stabilizing layers 74 and cementitious mixture 30. Prior to the liquid adhesive 70 curing and/or hardening, stabilizing layers 74 may be removed (e.g., while the adhesive is still tacky, etc.). Permeable layer 20 and/or impermeable layer 50 may thereafter be applied to the respective sides of cementitious mixture 30. In some embodiments, additional adhesive is applied after stabilizing layers 74 are removed to facilitate bonding permeable layer 20 and/or impermeable layer 50. Stabilizing layers 74 may be removed or disintegrated using a heating process or other process before connecting permeable layer 20 and/or impermeable layer 50.

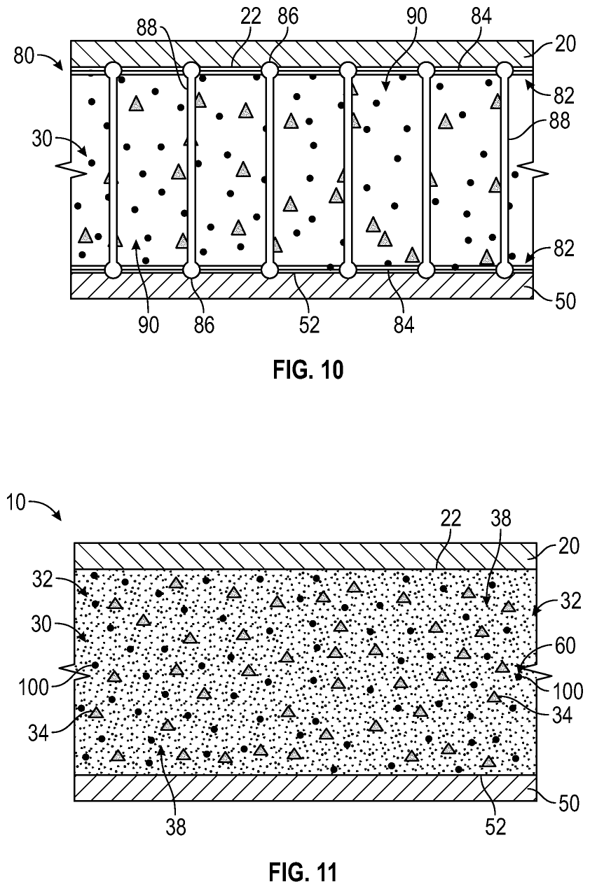

As shown in FIGS. 9 and 10, adhesive layer 60 may be formed from adhesive that dries, harden, cures, etc. into a rigid, three-dimensional structure (e.g., skeleton, space frame, microlattice structure, etc.), shown as geogrid 80. Geogrid 80 includes at least one layer (e.g., two, three, four, etc. layers), shown as strand layers 82. Each strand layer 82 includes a plurality of strands, shown as strands 84, that are interconnected at joints, shown as nodes 86, to cooperatively form strand layer 82. Strand layers 82 are attached in a spaced-apart configuration by coupling members (e.g., rods, extensions, beams, strands, trusses, etc.), shown as struts 88. According to an exemplary embodiment, struts 88 extend from nodes 86 of one strand layer 82 to corresponding nodes 86 of another strand layer 82. In some embodiments, geogrid 80 includes three or more strand layers 82 attached (e.g., stacked, etc.) by struts 88. According to an exemplary embodiment, struts 88 extend vertically from nodes 86 (e.g., perpendicular to strand layers 82, etc.). In other embodiments, struts 88 extend horizontally along a plane of strand layers 82. In other embodiments, struts 88 extend at an angle from strand layers 82 (e.g., forming a truss arrangement, etc.). In still other embodiments, struts 88 extends vertically, horizontally, at an angle, or combinations thereof. In some embodiments, multiple struts 88 extend from a single node 86. In some embodiments, certain nodes 86 do not include a corresponding strut 88 (e.g., not all nodes 86 have a strut 88 extending therefrom, etc.). In still other embodiments, one or more struts 88 are attached to strands 84 and/or adjacent struts 88 (i.e., have an end not connected to a node 86).

As shown in FIGS. 9 and 10, geogrid 80 includes void space (e.g., open space, air gaps, etc.), shown as void space 90, that is selected for particular density, weight, and other characteristics adhesive layer 60 and cementitious composite 10. In one embodiment, the volume of geogrid 80 includes a majority of void space 90 (e.g., 55%, 75%, 80%, 90%, 95%, 99%, 99.9%, etc.). The amount of volume of void space 90 may be based on at least one of the characteristics of strands 84 (e.g., size, length, height, thickness, shape, etc.), the spacing between strands 84, the arrangement of strands 84 (e.g., shape of strand layers 82, etc.), the characteristics of struts 88 (e.g., size, length, thickness, shape, etc.), and the number of struts 88 within geogrid 80 (e.g., density of struts 88 per unit of volume, etc.). According to an exemplary embodiment, a denser geogrid 80 may reduce the loss of cementitious mixture 30 during the transportation and handling of cementitious composite 10 and/or increase the strength of geogrid 80. In some embodiments, strand layers 82 of geogrid 80 include barbs, fibers, and/or an abrasive coating that provide for better bonding with cementitious mixture 30 (e.g., post-hydration, etc.).

According to an exemplary embodiment, geogrid 80 supports (i.e., holds, contains, reinforces) cementitious mixture 30. By way of example, strands 84 and/or struts 88 of geogrid 80 may physically support cementitious mixture 30. The size, shape, arrangement, and/or orientation of strands 84 and/or struts 88 that support cementitious mixture 30 may be designed to improve the structural properties and/or hydration characteristics of cementitious composite 10. By way of example, a slightly less-open space with more densely arranged strands 84 and/or struts 88 (i.e., less void space 90) may improve the strength of adhesive layer 60 but make it harder to fill.

As shown in FIG. 10, void spaces 90 are configured to receive and hold the constituents of cementitious mixture 30 such that cementitious mixture 30 is disposed within at least a portion of void spaces 90 of geogrid 80. According to an exemplary embodiment, cementitious mixture 30 is positioned within void spaces 90 using gravity, vibration, compaction, or any combination of gravity, vibration, and compaction. The extent that cementitious mixture 30 is compacted may be selected to provide a target ability of water to flow through cementitious mixture 30, time required for hydration, setting, and hardening of cementitious mixture 30, strength of cementitious composite 10, uniformity of the cementitious mixture 30, and/or the risk that cementitious material migrates through permeable layer 20. According to an exemplary embodiment, cementitious composite 10 includes voids filled with an adhesive. By way of example, cementitious mixture 30 may have voids therein (e.g., particularly formed therein, etc.). The voids may be naturally formed (e.g., due to the dimension and/or nature of the constituents of cementitious mixture 30, etc.) and/or may be formed using a shaper (e.g., a roller with protrusions thereon that are injected into cementitious composite 10, formed by injector 76, etc.). In one embodiment, liquid adhesive (e.g., liquid adhesive 70, etc.) is pumped and/or injected into the voids of cementitious mixture 30. In another embodiment, liquid adhesive is applied along a surface of cementitious mixture 30 such that the voids of cementitious mixture 30 are gravity filled as the liquid adhesive seeps into the voids. The voids of cementitious mixture 30 may form various structures therein. According to various embodiments, the liquid adhesive is pumped, injected, and/or gravity-fed into the voids after formation thereof in cementitious mixture 30 and/or the liquid adhesive is pumped, injected, and/or gravity fed into the voids during formation thereof in cementitious mixture 30. The liquid adhesive may set to form a structural component. The structural component may supplement or replace geogrid 80.

As shown in FIGS. 9 and 10, geogrid 80 includes a first strand layer 82 (e.g., bottom strand layer, lower strand layer, etc.) and a second strand layer 82 (e.g., top strand layer, lower strand layer, etc.) separated by the length of struts 88. As shown in FIG. 10, the first strand layer 82 of geogrid 80 is positioned along inner side 52 of impermeable layer 50. According to an exemplary embodiment, first strand layer 82 of geogrid 80 is coupled (e.g., attached, joined, bonded, etc.) to inner side 52 of impermeable layer 50 using a heating process (e.g., activated, heat welded, melted, bonded in a furnace, etc.) such that the adhesive thereof melts and attaches to impermeable layer 50. In one embodiment, first strand layer 82 of geogrid 80 is coupled to inner side 52 of impermeable layer 50 prior to cementitious mixture 30 being deposited along impermeable layer 50 and within void spaces 90 of geogrid 80. In another embodiment, the first strand layer 82 of geogrid 80 is coupled to inner side 52 of impermeable layer 50 after cementitious mixture 30 is deposited along impermeable layer 50 and within void spaces 90 of geogrid 80.

As shown in FIG. 10, the second strand layer 82 of geogrid 80 is positioned along inner side 22 of permeable layer 20. According to an exemplary embodiment, the second strand layer 82 of geogrid 80 is coupled (e.g., attached, joined, bonded, etc.) to inner side 22 of permeable layer 20 using a heating process (e.g., heat welded, melted, bonded in a furnace, etc.) such that the adhesive thereof melts and attaches to permeable layer 20. In one embodiment, the second strand layer 82 of geogrid 80 is coupled to inner side 22 of permeable layer 20 after depositing cementitious mixture 30 along impermeable layer 50 and within void spaces 90 of geogrid 80. In some embodiments, geogrid 80 includes one or more additional strand layers 82 disposed between the first and second strand layers 82. In one embodiment, the second strand layer 82 is cleaned (e.g., with pressurized air, with a brush, etc.) to remove cementitious material or other debris from nodes 86 and/or strands 84 of the second strand layer 82 prior to coupling. In another embodiment, cementitious mixture 30 is compacted within geogrid 80 (e.g., uniformly, evenly, etc.), thereby reducing the prevalence of cementitious material on the second strand layer 82.

In an alternative embodiment, a portion of structure layer 40 is used and adhesive layer 60 is used to attach structure layer 40 to at least one of permeable layer 20 and impermeable layer 50. Additionally or alternatively, grid layers or other permeable fabric layers may be layered into cementitious mixture and adhesive may be used to connect the various internal layer materials to the permeable layer 20 and/or the impermeable layer 50.

As shown in FIG. 11, various particles within cementitious mixture 30 are coated in an adhesive, shown as adhesive particles 100, prior to cementitious mixture 30 being disposed between permeable layer 20 and impermeable layer 50 (e.g., as a pre-step, etc.). Adhesive particles 100 may have a size of between 0.1 mm to 4 cm in diameter. Adhesive particles 100 may be sprayed with adhesive or absorb adhesive prior to being mixed into cementitious mixture 30 (e.g., between 10 and 50 times its initial weight in adhesive, etc.). Adhesive particles 100 may be solvent based (not water based) to prevent premature activation of cementitious mixture 30 (e.g., prevent activation before hydration, etc.). As shown in FIG. 12, adhesive particles 100 may be heat activated such that adhesive particles 100 melt, fuse, expand, or otherwise deform to form a connection structure, shown as interconnecting structure 102, having a plurality of strands extending throughout and within cementitious mixture 30.

The strands of interconnecting structure 102 may have varying densities throughout cementitious mixture 30 (e.g., based on the number of adhesive particles 100 in a given area of cementitious mixture 30, etc.). The thickness, density, shape, and/or quality of the strands may be related to the shape and size of voids 38, which are themselves related to at least the amount and size of aggregates 34 and the compressive force applied to cementitious composite 10. According to an exemplary embodiment, larger aggregates 34 are included within cementitious mixture 30 to create larger voids 38 to facilitate greater movement of the melted or expanding adhesive particles 100 within cementitious mixture 30 when forming interconnecting structure 102.

According to an exemplary embodiment, interconnecting structure 102 forms a structure layer that supports (e.g., holds, contains, reinforces, etc.) cementitious mixture 30. By way of example, the strands of interconnecting structure 102 may physically support cementitious mixture 30 (e.g., by filling voids 38, by forming around the constituent particles of cementitious mixture 30, etc.). The size, shape, orientation, and/or quantity of adhesive particles 100 that form interconnecting structure 102 may be designed to provide target structural properties and/or hydration characteristics of cementitious composite 10. By way of example, fewer voids 38 may produce a greater density of strands and improve the strength of cementitious mixture 30 but make it harder to hydrate.

According to an exemplary embodiment, the strands of interconnecting structure 102 attach to at least one of permeable layer 20 and impermeable layer 50 as a result of activation. By way of example, heat may be applied to cementitious composite 10 when cementitious mixture 30 is disposed on top of impermeable layer 50, and the strands of interconnecting structure 102 attach to impermeable layer 50. By way of another example, heat may be applied to cementitious composite 10 when cementitious mixture 30 is disposed between permeable layer 20 and impermeable layer 50, and the strands of interconnecting structure 102 may form therebetween and attach to permeable layer 20 and impermeable layer 50 (e.g., thereby coupling permeable layer 20 and impermeable layer 50 together, etc.).

According to an exemplary embodiment, interconnecting structure 102 is flexible. Permeable layer 20, interconnecting structure 102, and impermeable layer 50 may each be flexible. According to an exemplary embodiment, such a combination of flexible layers facilitates rolling and transporting cementitious composite 10, reducing the amount of cementitious mixture 30 that migrates through permeable layer 20. According to an alternative embodiment, interconnecting structure 102 is semi-rigid. Thus, cementitious composite 10 may be arranged in another configuration (e.g., various sheets that may be stacked, a sheet having a preformed shape, etc.).

### Securing Layer

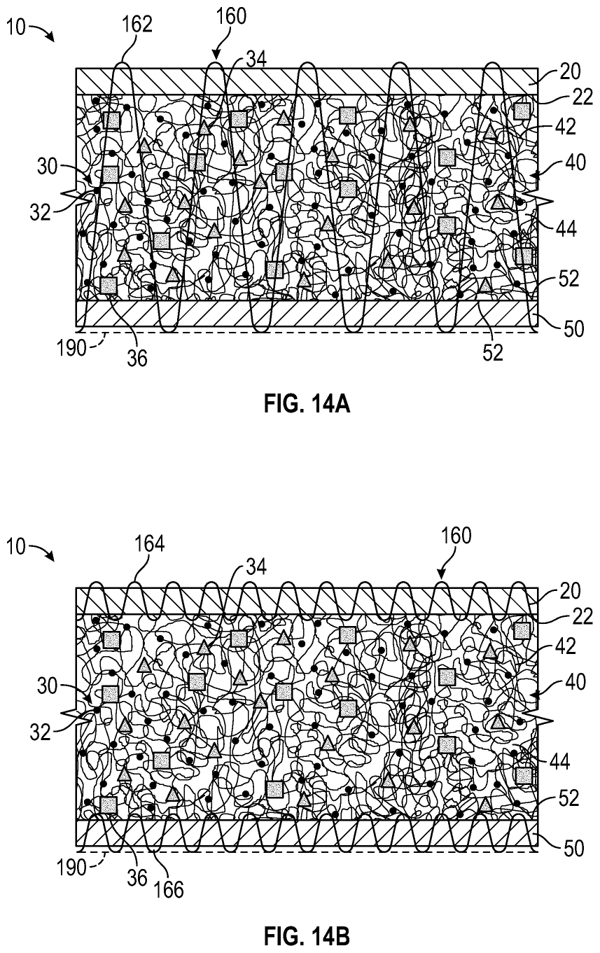

As shown in FIGS. 14A, 14B, 16A, 16B, 18-19E, 20B, and 20C, cementitious composite 10 includes a securing layer, shown as securing layer 160. According to an exemplary embodiment, securing layer 160 is configured to secure at least one of (i) impermeable layer 50 to structure layer 40 and/or interconnecting structure 140, (ii) permeable layer 20 to structure layer 40 and/or interconnecting structure 140, and (iii) permeable layer 20 to impermeable layer 50 (e.g., after cementitious mixture 30 and/or cementitious mixture 130 are disposed between permeable layer 20 and impermeable layer 50, etc.). As shown in FIGS. 14A, 16A, 16B, and 18-19E, securing layer 160 includes a strand, shown as strand 162, that is sewn into and extends between permeable layer 20 and impermeable layer 50 in an intersecting pattern to secure the two layers together. As shown in FIG. 16A, strand 162 is sewn into cementitious composite 10 prior to the activation of beads 132 to secure permeable layer 20 to impermeable layer 50. In some embodiments, strand 162 is sewn into cementitious composite 10 following the activation of beads 132. As shown in FIG. 14B, securing layer 160 includes a first strand, shown as upper strand 164, that is sewn into and secures permeable layer 20 to the top side of structure layer 40 (e.g., at receiving points on structure layer 40, etc.) and a second strand, shown as lower strand 166, that is sewn into and secures impermeable layer 50 to the bottom side of structure layer 40 (e.g., at receiving points on structure layer 40, etc.). In other embodiments, securing layer 160 of cementitious composite 10 includes only one of upper strand 164 and lower strand 166. In some embodiments, securing layer 160 of cementitious composite 10 includes strand 162 to secure permeable layer 20 to impermeable layer 50 and at least one of (i) upper strand 164 to secure permeable layer 20 to the top side of structure layer 40 and (ii) lower strand 166 to secure impermeable layer 50 to the bottom side of structure layer 40. Strand 162, upper strand 164, and/or lower strand 166 may include or be manufactured from string, thread, cord, wire, yarn, metal, plastics, and/or other suitable materials. Strand 162, upper strand 164, and/or lower strand 166 may be cord, yarn, fiber, nonwoven, a monofilament (e.g., a single filament, etc.), a multifilament, and/or braided.

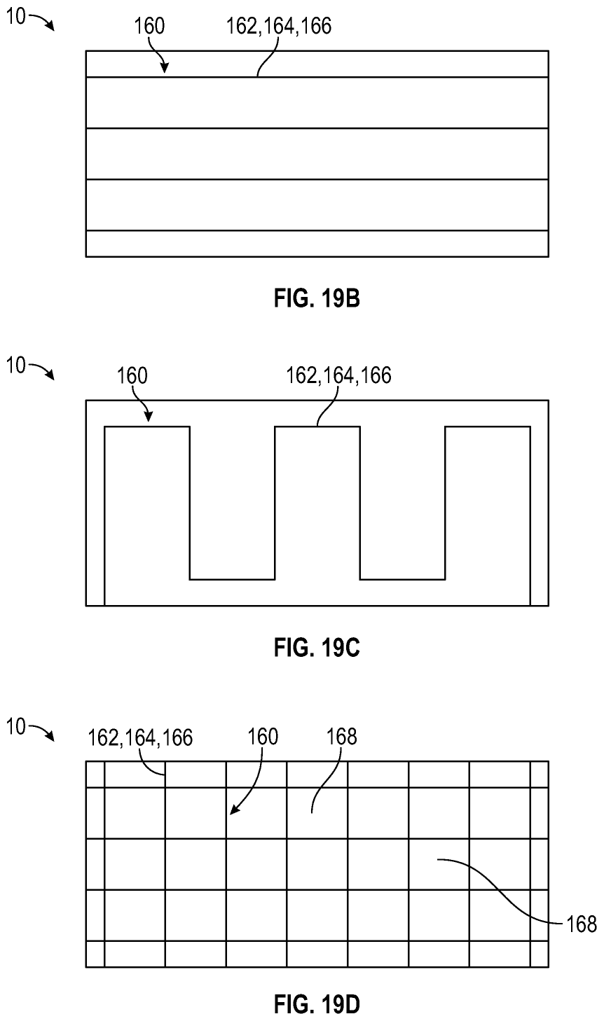

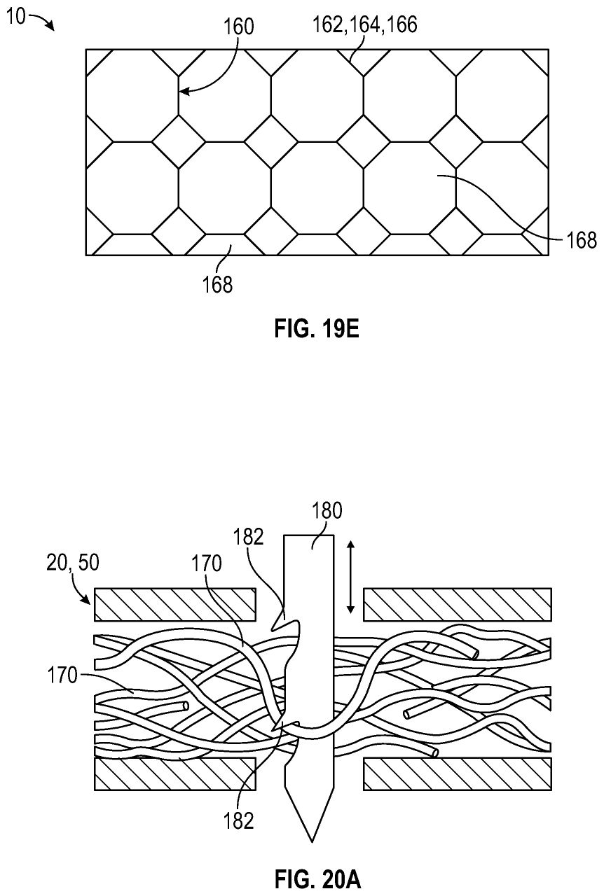

According to an exemplary embodiment, strand 162, upper strand 164, and/or lower strand 166 are sewn into cementitious composite 10 using a quilting process. In some embodiments, strand 162, upper strand 164, and/or lower strand 166 are single, continuous strands that extends along the width of cementitious composite 10 (e.g., a continuous weave in the width direction, etc.). As shown in FIG. 19A, cementitious composite 10 includes a plurality of strands 162, upper strands 164, and/or lower strands 166 arranged in parallel along the longitudinal length of cementitious composite 10, each extending in the width direction. In some embodiments, strand 162, upper strand 164, and/or lower strand 166 are single, continuous strand that extends along the longitudinal length of cementitious composite 10 (e.g., a continuous weave in the length direction, etc.). As shown in FIG. 19B, cementitious composite 10 includes a plurality of strands 162, upper strands 164, and/or lower strands 166 arranged in parallel along the width of cementitious composite 10, each extending in the length direction. In some embodiments, strand 162, upper strand 164, and/or lower strand 166 are single, continuous strands that extends along the longitudinal length and the width of cementitious composite 10 (e.g., a continuous weave in the length and width directions, etc.). As shown in FIG. 19C, cementitious composite 10 includes a single strand 162, a single upper strand 164, and/or a single lower strand 166 that extends along the longitudinal length and the width of cementitious composite 10 continuously up and down the width of cementitious composite 10 along the longitudinal length thereof (e.g., in a zig-zag pattern, etc.).

In some embodiments, strands 162, upper strands 164, and/or lower strands 166 are sewn into cementitious composite 10 in a geometric pattern. As shown in FIGS. 19D and 19E, cementitious composite 10 includes a plurality of strands 162, upper strands 164, and/or lower strands 166 arranged such that a plurality of discrete compartments, shown as pockets 168, are formed within cementitious composite 10. Each pocket 168 may be configured to hold a target amount of cementitious mixture 30 and/or cementitious mixture 130 therein. As shown in FIG. 19D, strands 162, upper strands 164, and/or lower strands 166 are sewn into cementitious composite 10 in a cross-hatch pattern such that pockets 168 have a rectangular or square cross-sectional shape. As shown in FIG. 19E, strands 162, upper strands 164, and/or lower strands 166 are sewn into cementitious composite 10 in a pattern such that pockets 168 have an octagonal cross-sectional shape. In other embodiments, strands 162, upper strands 164, and/or lower strands 166 are sewn into cementitious composite 10 in another pattern such that pockets 168 have another geometrical cross-sectional shape (e.g., triangular, diamond, trapezoidal, hexagonal, etc.). In still other embodiments, strands 162, upper strands 164, and/or lower strands 166 are sewn into cementitious composite 10 in a random or pseudo-random pattern.

In some embodiments, cementitious composite 10 includes two permeable layers 20. By way of example, (i) a first permeable layer 20 may be disposed on the bottom of cementitious mixture 30 and/or cementitious mixture 130 and (ii) a second permeable layer 20 may be disposed on the top of cementitious mixture 30 and/or cementitious mixture 130. The first and second permeable layers 20 may be woven together with securing layer 160 (e.g., strand 162, upper strand 164, lower strand 166, etc.). The first and second permeable layers 20 may have less than 50% void space. In one embodiment, the first and second permeable layers 20 have less 5% void space (e.g., not substantially permeable, only partially permeable, etc.).

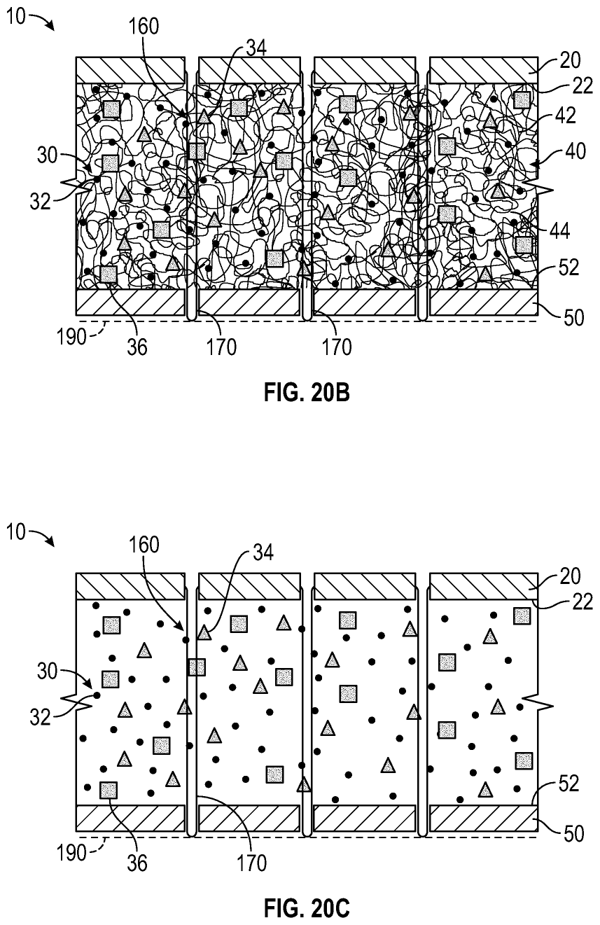

In some embodiments, permeable layer 20, impermeable layer 50, structure layer 40, and/or interconnecting are additionally or alternatively secured together using a needle punching process to create securing layer 160. As shown in FIG. 20A, a needle 180 is punched through permeable layer 20 and/or impermeable layer 50 such that barbs 182 and/or the point of needle 180 pull on fibers 170 thereof across the thickness of cementitious composite 10. As shown in FIG. 20A, barbs 182 are angled downward such that needle 180 pulls on fibers 170 on a downward stroke. In other embodiments, barbs 182 are angled upward such that needle 180 pulls on fibers 170 on an upward stroke. In still other embodiments, barbs 182 are angled upward and downward such that needle 180 pulls on fibers 170 on the upward stroke and the downward stroke. In an alternative embodiment, needle 180 does not include barbs 182, but rather the nose of needle 180 pulls of fibers 170. In such an embodiment, the nose of needle 180 may be pronged with two points positioned closely together that catch fibers 170. Needle 180 may also include both barbs 182 and the pronged nose. In some embodiments, a needle punching machine includes a plurality of needles 180 arranged in series (e.g., more than 10, 20, 50, 100, 500, etc. needles 180). The needle punching machine may be configured to fire or punch the plurality of needles all at the same time and/or speed or at different times and/or speed depending on the machine configuration.

In one embodiment, permeable layer 20 is a non-woven fabric material (e.g., a felted material, etc.) such that barbs 182 pull on fibers 170 of permeable layer 20 when needle 180 is punched therethrough. In another embodiment, impermeable layer 50 is a non-woven fabric material (e.g., a felted material, etc.) such that barbs 182 pull on fibers 170 of impermeable layer 50 when needle 180 is punched therethrough. In some embodiments, permeable layer 20 and impermeable layer 50 are non-woven fabric materials. According to an exemplary embodiment, fibers 170 of permeable layer 20 and/or fibers 170 of impermeable layer 50 are pulled by barbs 182 of needle 180 and punched through the other layers (e.g., fibers 170 of permeable layer 20 are punched through impermeable layer 50, fibers 170 of impermeable layer 50 are punched through permeable layer 20, etc.) such that fibers 170 interlock with the other layers. As shown in FIGS. 20B and 20C, fibers 170 of permeable layer 20 are pulled therefrom across the thickness of cementitious composite 10 (e.g., by barbs 182 of needle 180, etc.) and punched through impermeable layer 50 and interlocked therewith to secure permeable layer 20 to impermeable layer 50. In some embodiments, fibers 170 of impermeable layer 50 are additionally or alternatively pulled therefrom across the thickness of cementitious composite 10 and punched through permeable layer 20 and interlocked therewith to secure impermeable layer 50 to permeable layer 20. Fibers 170 may be pulled from and punched through permeable layer 20 and/or impermeable layer 50 in any suitable arrangement (e.g., similar to the arrangement of strands 162, upper strands 164, and/or lower strands 166 described above in relation to FIGS. 19A-19E, etc.). In some embodiments, the ends of fibers 170 punched through permeable layer 20 and/or impermeable layer 50 are further bonded to the outer surface of such layers using adhesive, using a heat treatment process, ultrasonically, and/or still otherwise bonded thereto.

In some embodiments, cementitious composite 10 includes a target volume of stands 162 and/or fibers 170 extending through cementitious mixture 30 and/or cementitious mixture 130. The target volume of stands 162 and/or fibers 170 may improve various properties of cementitious composite 10 including strain hardening, crack resistance, flexural strength, and/or still other properties of cementitious composite 10 (e.g., following in-situ hydration, etc.). In one embodiment, strands 162 and/or fibers 170 account for at least 5% of the volume between permeable layer 20 and impermeable layer 50. In some embodiments, strands 162 and/or fibers 170 account for as much as 10%, 15%, 20%, 25%, etc. of the volume between permeable layer 20 and impermeable layer 50. In some embodiments, strands 162 and/or fibers 170 account for less than 5% of the volume between permeable layer 20 and impermeable layer 50.

In some embodiments, portions or areas of cementitious composite 10 have a higher concentration of strands 162 and/or fibers 170 than other portions or areas of the cementitious composite 10. The higher concentration areas of strands 162 and/or fibers 170 may form pockets within cementitious composite 10 that provide localized reinforcement (e.g., relative to the other portions of cementitious composite 10 that have a lesser concentration of strands 162 and/or fibers 170, etc.).

### Permeable Layer

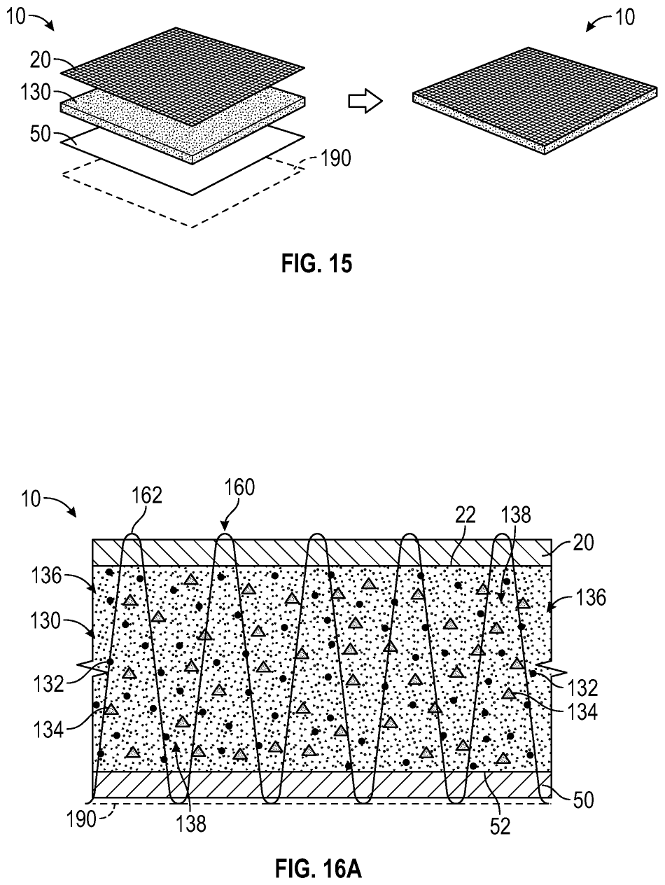

According to the exemplary embodiment shown in FIGS. 2-6, 8, 10-18, 20B, and 20C, permeable layer 20 facilitates the dispersion of a fluid (e.g., water, etc.) into cementitious composite 10 while retaining cementitious mixture 30 and/or cementitious mixture 130. Permeable layer 20 may include specified characteristics that manage the flow of the fluid through permeable layer 20. According to an exemplary embodiment, the specified characteristics allow for the hydration of cementitious mixture 30 and/or cementitious mixture 130 without allowing cementitious materials 32, aggregates 34, absorbent material 36, aggregates 134, cementitious material 136, and/or additives to migrate from cementitious composite 10 (e.g., during handling before in-situ hydration, during in-situ hydration, etc.). In other embodiments, the specified characteristics may also maintain the mix ratio of cementitious mixture 30 and/or cementitious mixture 130 during the hydration and hardening processes. Further, permeable layer 20 may maintain the level of compaction of cementitious mixture 30 and/or cementitious mixture 130 by applying consistent pressure to cementitious mixture 30 and/or cementitious mixture 130, respectively. According to an exemplary embodiment, less than 10 percent by weight of cementitious mixture 30 and/or cementitious mixture 130 migrates through permeable layer 20 prior to in-situ hydration. In some embodiments, up to 10 percent by weight of cementitious mixture 30 and/or cementitious mixture 130 may migrate through permeable layer 20 while maintaining adequate performance of cementitious composite 10 after in-situ hydration.

According to an exemplary embodiment, permeable layer 20 includes a woven or nonwoven polyolefin (e.g., polypropylene, etc.). Permeable layer 20 may include the same or a similar material as structure layer 40 and/or interconnecting structure 140 (e.g., beads 132, etc.). Manufacturing both permeable layer 20 and structure layer 40 and/or interconnecting structure 140 from similar materials facilitates the coupling of permeable layer 20 to structure layer 40 and/or interconnecting structure 140 (e.g., by melting, ultrasonic welding, adhesive, the strands thereof, etc.) and increases bond strength between permeable layer 20 and structure layer 40 and/or interconnecting structure 140. According to an alternative embodiment, permeable layer 20 and structure layer 40 and/or interconnecting structure 140 (e.g., beads 132, etc.) include different materials but may still be coupled together (e.g., with an adhesive, with adhesive layer 60, with adhesive layer 60, by melting the two together, etc.). By way of example, permeable layer 20 may include a sand blasting fabric having a resistance to ultraviolet light (e.g., white FR/UV sandblasting fabric 27600 as manufactured by TenCate, NW6 polypropylene fabric manufactured by Colbond, etc.). According to an exemplary embodiment, permeable layer 20 has a weight of approximately six ounces per square yard. According to an alternative embodiment, permeable layer 20 includes Grade 354 Airtex as manufactured by Georgia-Pacific, which has a weight of between 0.16 and 0.32 ounces per square foot.

According to an exemplary embodiment, permeable layer 20 includes a plurality of apertures, among other features, having a specified shape, area, frequency, and/or spacing. By way of example, the apertures may have a specified shape (e.g., circular, ovular, rectangular, etc.), depending on the particular application of cementitious composite 10. According to an exemplary embodiment, the size of the apertures may also be specified. By way of example, oversized apertures may allow sieving of cementitious mixture 30 and/or cementitious mixture 130 prior to in-situ hydration. In contrast, undersized apertures may provide too slow or incomplete hydration of cementitious mixture 30 and/or cementitious mixture 130. According to an exemplary embodiment, the apertures are designed to prevent particles less than fifteen microns from migrating from cementitious composite 10 and have an area of between 0.001 and 3 square millimeters. According to an exemplary embodiment, the frequency of the apertures may be specified to facilitate the transfer of water into cementitious mixture 30 and/or cementitious mixture 130. According to an exemplary embodiment, permeable layer 20 includes between one and twelve thousand apertures per square inch. According to an alternative embodiment, permeable layer 20 is a permeable material that does not include apertures (e.g., a fibrous material, paper, etc.).

According to an exemplary embodiment, permeable layer 20 is coupled to structure layer 40, interconnecting structure 140, and/or adhesive layer 60 during the manufacturing process. Such a permeable layer 20 may be designed as a removable product that does not remain coupled with structure layer 40, interconnecting structure 140, and/or adhesive layer 60 throughout the life of cementitious composite 10. According to an exemplary embodiment, permeable layer 20 includes a containment sheet (e.g., biodegradable paper, water soluble plastic, etc.) that secures cementitious mixture 30 and/or cementitious mixture 130 during the transportation of cementitious composite 10. In some embodiments, the containment sheet may be removed before or after the cementitious composite 10 is in place in the field. Such removal of the containment sheet may occur either before or after in-situ hydration. In either embodiment, permeable layer 20 may include flow channels (e.g., perforations, etc.) designed to facilitate the flow of water into cementitious mixture 30 and/or cementitious mixture 130. In some embodiments, outer side 24 of permeable layer 20 has a texture and/or defines channels that are conducive to the transport of water (e.g., to remove water from outer side 24, to direct water from outer side 24, etc.). According to an alternative embodiment, permeable layer 20 is not removed and erodes in the field from weathering without compromising the structural performance of cementitious composite 10. According to an alternative embodiment, permeable layer 20 is treated with a coating (e.g., for ultraviolet resistance, abrasion resistance, etc.) to extend service life in the field (e.g., to prevent weathering, etc.). The coating may be applied (e.g., painted, sprayed, etc.) to permeable layer 20 before or after the quilting and/or needle punching process is completed. Alternatively, the permeable layer 20 is manufactured from a more durable material to prevent weathering (e.g., a ceramic material, a metallic material, etc. such that a coating is not needed).

According to an exemplary embodiment, permeable layer 20 includes a water soluble material (e.g., a cold water soluble material, etc.). In some embodiments, the water soluble material is a fabric material or a film material, and such fabric material may be woven or nonwoven. In one embodiment, the fabric material is a cold water soluble nonwoven material manufactured from partially hydrolyzed polyvinyl alcohol fibers (a PVA fabric). The PVA fabric may be impermeable to cementitious materials, thereby reducing the migration of cementitious mixture 30 and/or cementitious mixture 130 from cementitious composite 10. In some embodiments, the PVA fabric is permeable to water. In other embodiments, the PVA fabric substantially retains water until the water soluble material disintegrates. In still other embodiments, the PVA fabric is substantially impermeable to water until the water soluble material disintegrates. In some embodiments, permeable layer 20, strand 162, upper strand 164, and/or fibers 170 of permeable layer 20 are water soluble, while impermeable layer 50, lower strand 166, and/or fibers 170 of impermeable layer 50 may not be water permeable (e.g., to add reinforcement to cementitious composite 10, etc.). In some embodiments, permeable layer 20 is color changing or includes a coating that is color changing when a specific amount of water is added to cementitious composite 10 during in-situ hydration to inform an installer when a target amount of water has been applied thereto.

In some embodiments, permeable layer 20 includes two layers that are coupled together (e.g., joined, fused, integrated, etc.). By way of example, permeable layer 20 may include a first or exterior layer and a second or interior layer. The exterior layer may be configured to provide a relatively flat surface and the interior layer may be a felted material. The exterior layer still allows for needles to pass therethrough (e.g., the exterior layer defines a plurality of predefined holes for the needles to pass through, the needles are capable of punching therethrough, etc.), but the strand 162 and/or fibers 170 (e.g., of the interior layer) do not protrude above the exterior layer (e.g., the exterior layer is relatively flat and smooth, etc.). Such an exterior layer may improve the aesthetics of cementitious composite 10 and/or improve the outer surface properties of permeable layer 20 (e.g., relative to a nonwoven felt material, etc.). In some embodiments, the exterior layer is treated with a coating (e.g., to improve weathering, abrasion, etc. resistance).

According to an exemplary embodiment, permeable layer 20 has a surface (e.g., a nonwoven surface, etc.) having a roughness selected to facilitate bonding (e.g., a large surface roughness such that adhesive layer 60, structure layer 40, and/or interconnecting structure 140 better bond to inner side 22 of permeable layer 20, etc.). According to another exemplary embodiment, permeable layer 20 is treated with a coating to facilitate bonding (e.g., a fusible water soluble embroidery stabilizer, “Wet N Gone Fusible®”, etc.).

According to an exemplary embodiment, inner side 22 of permeable layer 20 is bonded to structure layer 40, interconnecting structure 140, and/or adhesive layer 60 after a heat treatment process. In one embodiment, permeable layer 20 has a melting point that is greater than the melting point of structure layer 40, interconnecting structure 140 (e.g., beads 132, etc.), and/or adhesive layer 60. By way of example, PVA fabric may have a melting point of between 356 and 374 degrees Fahrenheit. Permeable layer 20 (e.g., a PVA fabric, etc.) may be placed in contact with portions of (i) structure layer 40 and/or interconnecting structure 140 that may protrude from cementitious mixture 30 and/or cementitious mixture 130 and/or (ii) adhesive layer 60. Heat may be subsequently applied (e.g., topically, etc.) to permeable layer 20 (e.g., with a heated roller, with a heated air stream, with a hot plate, with a furnace, etc.) to melt the ends of the portions of the structure layer 40, interconnecting structure 140, and/or adhesive layer 60 without melting permeable layer 20, thereby bonding permeable layer 20 with structure layer 40, interconnecting structure 140, and/or adhesive layer 60.

By way of example, the applied heat may deform the portions of structure layer 40, interconnecting structure 140, and/or adhesive layer 60 disposed along inner side 22 of permeable layer 20 (e.g., a PVA fabric, etc.). The portions of structure layer 40, and/or interconnecting structure 140, and/or adhesive layer 60 internal to cementitious mixture 30 and/or cementitious mixture 130 may remain intact (i.e., may not melt) even after the application of heat. The permeable layer 20 may be in contact with cementitious mixture 30 and/or cementitious mixture 130 (e.g., may fuse against cementitious mixture 30, etc.) after heating, thereby retaining cementitious mixture 30 and/or cementitious mixture 130, and restricting movement of cementitious materials 32, aggregates 34, absorbent material 36, aggregates 134, cementitious material 136, and/or additives within cementitious composite 10. By way of example, a heated roller or plate may be used to both heat permeable layer 20 and compress cementitious composite 10. By way of another example, a temperature neutral roller or a cooled roller may be used to apply compression to permeable layer 20 after the application of heat. Such an additional roller may also cool permeable layer 20. According to an alternative embodiment, permeable layer 20 has a melting point that is less than or equal to the melting point of structure layer 40, interconnecting structure 140 (e.g., beads 132, etc.), and/or adhesive layer 60.

In one embodiment, permeable layer 20 is positioned along a top surface of structure layer 40, interconnecting structure 140, cementitious mixture 30, and/or cementitious mixture 130. According to another embodiment, permeable layer 20 is positioned along the top surface and at least one side surface of structure layer 40, interconnecting structure 140, cementitious mixture 30, and/or cementitious mixture 130. Permeable layer 20 may be (i) bonded with only the top surface of structure layer 40 and/or cementitious mixture 30, (ii) bonded with only at least one side surface of structure layer 40, interconnecting structure 140, cementitious mixture 30, and/or cementitious mixture 130, or (iii) along both the top surface and at least one side surface of structure layer 40, interconnecting structure 140, cementitious mixture 30, and/or cementitious mixture 130, according to various alternative embodiments.

According to another embodiment, permeable layer 20 is bonded with impermeable layer 50. By way of example, permeable layer 20 may include a material having a first melting point (e.g., PVA having a melting point of between 356 and 374 degrees Fahrenheit, etc.), and impermeable layer 50 may include a material having a second melting point (e.g., a polypropylene material having a melting point of between 266 and 340 degrees Fahrenheit, etc.). In one embodiment, the first melting point is greater than the second melting point such that the application of heat to the seam between permeable layer 20 and impermeable layer 50 melts impermeable layer 50 to form a bond without melting permeable layer 20. In another embodiment, the second melting point is greater than the first melting point such that the application of heat to the seam between permeable layer 20 and impermeable layer 50 melts permeable layer 20 to form a bond without melting impermeable layer 50. In still another embodiment, permeable layer 20 and impermeable layer 50 have the same melting point. In yet another alternative embodiment, the application of heat melts a coupling material (e.g., a material having a melting point below that of permeable layer 20 and impermeable layer 50, etc.) to form a bond.

Permeable layer 20 may abut or partially overlap impermeable layer 50. Double-sided tape and/or adhesive may be applied to a periphery of permeable layer 20 to secure permeable layer 20 to impermeable layer 50. By way of example, impermeable layer 50 may include a flange extending laterally outward from structure layer 40, interconnecting structure 140, cementitious mixture 30, cementitious mixture 130, and/or adhesive layer 60, and permeable layer 20 may extend down the sides of structure layer 40, interconnecting structure 140, cementitious mixture 30, cementitious mixture 130, and/or adhesive layer 60 and along the flange of impermeable layer 50. Such overlap may facilitate bonding the two layers together. In one embodiment, permeable layer 20 is bonded to impermeable layer 50, thereby forming a sealed pocket that envelopes structure layer 40, interconnecting structure 140, cementitious mixture 30, cementitious mixture 130, and/or adhesive layer 60. Alternatively, permeable layer 20 may be folded under impermeable layer 50 to seal the edges of cementitious composite 10 such that cementitious mixture 30 and/or cementitious mixture 130 does not migrate from cementitious composite 10 through the edges during handling. The permeable layer 20 may be secured to the bottom of impermeable layer 50 using adhesive, by applying heat, and/or mechanically (e.g., with fasteners, etc.).

In some embodiments, inner side 22 of permeable layer 20 is coated with an adhesive (e.g., adhesive coating, adhesive layer 60, etc.) configured to attach the permeable layer 20 to the top surface of structure layer 40, interconnecting structure 140, cementitious mixture 30, and/or cementitious mixture 130. The adhesive coating may be a water soluble adhesive that includes a curing agent. In other embodiments, the inner side 22 is coated with another type of curing agent (e.g., without adhesive, etc.). By way of example, the water soluble adhesive and/or the curing agent may be absorbed by cementitious mixture 30 and/or cementitious mixture 130 during in-situ hydration. Such absorption of the adhesive and/or the curing agent during hydration may improve the properties (e.g., flexural strength, etc.) of cementitious composite 10 upon setting, curing, hardening, etc. In one embodiment, the curing agent is mixed with the water soluble adhesive and thereafter applied. In another embodiment, the curing agent is positioned underneath the water soluble adhesive (e.g., between inner side 22 of permeable layer 20 and the water soluble adhesive, etc.).

In some embodiments, the water soluble material of permeable layer 20 is treated to provide a desired disintegration time. By way of example, permeable layer 20 may be treated with paint, glued fibers, glued sand, water soluble adhesives, and/or other materials to modify (e.g., increase, decrease, etc.) the disintegration time of the permeable layer 20 during in-situ hydration. Such treatment of the permeable layer 20 may provide the desired disintegration time to (i) enhance the curing properties of cementitious composite 10, (ii) further prevent and/or reduce the washout of cementitious mixture 30 and/or cementitious mixture 130 from cementitious composite 10, and/or (iii) prevent premature exposure of the cementitious mixture 30 and/or cementitious mixture 130 to the surrounding environment (e.g., sun exposure, wind exposure, etc.). The treated permeable layer 20 (e.g., including fibers, sand, etc.) may be washed away from cementitious composite 10 post-in-situ hydration and/or pressed into cementitious composite 10 post-in-situ hydration to thereby become a permanent part thereof.

Cementitious composite 10 may be positioned and hydrated in-situ. According to an exemplary embodiment, permeable layer 20 is a water soluble material (e.g., PVA fabric, etc.). After installation of cementitious composite 10, an operator may apply water topically to hydrate cementitious mixture 30 and/or cementitious mixture 130. In one embodiment, the water soluble material prevents displacement of cementitious mixture 30 and/or cementitious mixture 130 (i.e., prevents the cementitious material from washing away) until the water soluble material disintegrates. Such protection may facilitate the use of higher-pressure water sources during the hydration process. A disintegration time for the water soluble material may be selected to facilitate hydration. By way of example, the disintegration time may be less than one minute. According to an exemplary embodiment, water soluble material is positioned along the sides of structure layer 40, interconnecting structure 140, adhesive layer 60, cementitious mixture 30, and/or cementitious mixture 130 such that, upon application of water, the water soluble fabric disintegrates. Upon the application of water, cementitious mixture 30 and/or cementitious mixture 130 begins its initial setting period.

In one embodiment, cementitious materials 32, absorbent material 36, cementitious material 136, and/or additives positioned along the water soluble material may begin to lock, set, or “gel” within structure layer 40, interconnecting structure 140, and/or adhesive layer 60 to prevent washout of the mix (e.g., cementitious materials 32, aggregates 34, aggregates 134, cementitious material 136, etc. positioned along a middle portion of cementitious mixture 30 and/or cementitious mixture 130, etc.). In another embodiment, the mix of cementitious materials 32 and/or absorbent material 36 within cementitious mixture 30 and/or cementitious material 136 within cementitious mixture 130 are designed to partially diffuse such that a small portion of the mix flows laterally outward before or during the initial setting. Such lateral flow may facilitate the coupling of adjacent panels or rolls of cementitious composite 10 (e.g., panels or rolls positioned along one another, panels or rolls touching one another, panels or rolls spaced two millimeters or another distance from one another, etc.). By way of example, cementitious materials 32, absorbent material 36, cementitious material 136, and/or additives along the permeable layers of two adjacent panels may begin to gel during the initial setting period and bond together, thereby fusing the adjacent panels or rolls. By way of another example, cementitious materials 32, absorbent material 36, cementitious material 136, and/or additives from adjacent panels or rolls may mix together and harden to form a rigid joint. In some embodiments, the composition of cementitious mixture 30 and/or cementitious mixture 130 are designed to facilitate such lateral coupling. In one embodiment, the water soluble material facilitates the transport of water into cementitious composite 10. By way of example, the water soluble material may include apertures to facilitate water flow, a woven configuration that transports the water into cementitious mixture 30 and/or cementitious mixture 130, or still another structure. By way of another example, the surface of cementitious mixture 30 and/or cementitious mixture 130 positioned along the water soluble material may begin to gel and (i) retain (e.g., reduce the migration of, contain, limit movement of, etc.) cementitious materials 32, aggregates 34, aggregates 134, cementitious material 136, and/or additives positioned within a middle portion of cementitious mixture 30 and/or cementitious mixture 130 and/or (ii) facilitate the flow of water into cementitious mixture 30 and/or cementitious mixture 130. Cementitious materials 32, absorbent material 36, cementitious material 136, and/or additives within cementitious mixture 30 and/or cementitious mixture 130 may be activated during and following the disintegration process of the water soluble material. After the disintegration time, cementitious composite 10 may have a bare surface (e.g., cementitious mixture 30 is exposed after hardening, etc.).

According to still another alternative embodiment, permeable layer 20 may include a coating (e.g., elastomeric coatings, acrylic coatings, butyl rubber coatings, Hypalon® coatings, Neoprene® coatings, silicone coatings, modified asphalt coatings, acrylic lacquer coatings, urethane coatings, polyurethane coatings, polyurea coatings, one of various coatings approved for potable water, any combination of two or more coating materials, etc.). Such a coating may be applied through various known techniques (e.g., spraying, etc.) in one of a single and plural component form such that the material dries (i.e., sets, cures) into one of a permeable and impermeable coating. According to an exemplary embodiment, permeable layer 20 is AquaVers 405 as manufactured by Versaflex and has a thickness of between 0.07 and 2.0 millimeters. According to an alternative embodiment, the coating is another material having a low modulus of elasticity and a percent elongation of between 5 and 1000 percent. According to an alternative embodiment, a primer may be applied to a side of structure layer 40, interconnecting structure 140, cementitious mixture 30, cementitious mixture 130, and/or adhesive layer 60 before permeable layer 20 is sprayed on to improve bond strength (e.g., epoxy primers, acrylic primers, etc.). According to an alternative embodiment, additional treatment coatings may be applied to permeable layer 20 (e.g., to change the texture, color, etc. of permeable layer 20). In some embodiments, the additional treatment coating may be applied after an initial coating is applied. In still other embodiments, the additional treatment coating is applied over the various other materials discussed above for permeable layer 20 (e.g., woven or nonwoven polyolefin, etc.).

According to an exemplary embodiment, coating materials used for permeable layer 20 include three dimensional voids. Such a three dimensional void may include a sidewall configured to secure cementitious mixture 30 and/or cementitious mixture 130 within cementitious composite 10. According to an exemplary embodiment, the three dimensional void is cone shaped. Such a cone shaped three dimensional void includes a larger cross sectional area along an outer surface of permeable layer 20 to draw water inward and a smaller cross sectional area proximate to cementitious mixture 30 and/or cementitious mixture 130 to prevent cementitious mixture 30 and/or cementitious mixture 130 from migrating out of cementitious composite 10. According to an alternative embodiment, the three dimensional void may have another shape (e.g., tetrahedral, etc.). Apertures having various shapes (e.g., triangle, circle, oval, diamond, square, rectangle, octagon, etc.) may also be formed in the coating.

Where permeable layer 20 includes a coating, three dimensional voids or apertures (e.g., tetrahedral shaped, diamond shaped, etc.) may partially close when cementitious composite 10 is rolled. Partially closing the apertures may better secure cementitious mixture 30 and/or cementitious mixture 130 (e.g., during transportation, etc.). Certain shapes (e.g., tetrahedral, diamond, etc.) may close more securely than other shapes. As the radius of curvature increases from rolling, tension on permeable layer 20 increases and deforms the coating in the direction of the curve. Such deformation decreases the size (e.g., diameter, etc.) of the three dimensional voids or apertures in direction opposite of the curve. According to an exemplary embodiment, three dimensional void or aperture returns to its original shape and size when unrolled.

According to an alternative embodiment, forming three dimensional voids or apertures with a material removal tool (e.g., laser, electron beam, a blade, etc.) fully removes the coating material in the three dimensional void or aperture. Such a process may prevent the three dimensional voids or apertures from closing or refilling. Apertures otherwise formed (e.g., with a point, etc.) may become refilled and require subsequent processing.

According to an alternative embodiment, permeable layer 20 is manufactured from a coating material that dries water-permeable such that apertures are not necessary to facilitate the transfer of hydration water. However, perforations may be added to permeable layer 20 including a water-permeable material to further promote the hydration of cementitious mixture 30 and/or cementitious mixture 130. According to an alternative embodiment, a side of structure layer 40, interconnecting structure 140, adhesive layer 60, cementitious mixture 30, and/or cementitious mixture 130 is not entirely covered by the coating but nonetheless contains cementitious mixture 30 and/or cementitious mixture 130 and allows for hydration (e.g., without the need for separate three dimensional voids or apertures).

According to an exemplary embodiment, permeable layer 20 is sprayed onto a side of structure layer 40, interconnecting structure 140, adhesive layer 60, cementitious mixture 30, and/or cementitious mixture 130 and apertures are thereafter defined within permeable layer 20 (e.g., with a roller having points, a plate having points, etc.). Whether provided as a sheet, a product applied through spraying, or another product, permeable layer 20 may also include a texture (e.g., by including an abrasive within the coating, etc.) or coefficient of friction designed to allow for improved traction for objects (e.g., vehicles, people, etc.) moving across permeable layer 20. According to an alternative embodiment, permeable layer 20 may have a smooth surface, a surface designed to facilitate the flow of water into cementitious composite 10, or a decorative finish.

### Impermeable Layer

Referring to the exemplary embodiment shown in FIGS. 2-6, 8, 10-18, 20B, and 20C, impermeable layer 50 includes a material capable of retaining cementitious mixture 30 and/or cementitious mixture 130 and hydration water without degrading after interacting with cementitious mixture 30 (e.g., cementitious materials 32, etc.) and/or cementitious mixture 130 (e.g., cementitious material 136, etc.). Impermeable layer 50 may serve as a base to place cementitious mixture 30 over. In one embodiment, impermeable layer 50 includes a plastic based material (e.g., polypropylene, PVC, polyolefin, polyethylene, etc.). In some embodiments, impermeable layer 50 includes the same material as structure layer 40 and/or interconnecting structure 140 (e.g., beads 132, etc.). Manufacturing both impermeable layer 50 and structure layer 40 and/or interconnecting structure 140 from similar materials facilitates increasing bond strength between impermeable layer 50 and structure layer 40 and/or interconnecting structure 140.

As shown in FIGS. 4-6, 8, 10-12, 14A, 14B, 16A, 16B, 18, and 20B, inner side 52 of impermeable layer 50 is coupled along a bottom surface of structure layer 40, adhesive layer 60, interconnecting structure 140, and/or cementitious mixture 30. Where impermeable layer 50 is positioned along the bottom surface of structure layer 40, adhesive layer 60, interconnecting structure 140, and/or cementitious mixture 30, impermeable layer 50 may experience a portion of the flexural and tensile stresses. Such a position may improve the strength and ductility of cementitious composite 10. In some embodiments, impermeable layer 50 is a sheet that includes a flexible material (e.g., to facilitate rolling cementitious composite 10, etc.) that is capable of being coupled with structure layer 40, adhesive layer 60, interconnecting structure 140, and/or cementitious mixture 30 without allowing a fluid to seep through. According to an alternative embodiment, impermeable layer 50 may be integrally formed with or otherwise coupled to structure layer 40, interconnecting structure 140, and/or adhesive layer 60. According to an alternative embodiment, impermeable layer 50 may protect cementitious mixture 30 and/or cementitious mixture 130 from exposure to certain chemicals (e.g., from sulfate introduced by soils in the field, etc.). In some embodiments, outer side 54 of impermeable layer 50 includes protrusions (e.g., extensions, barbs, etc.). The protrusions may facilitate securing cementitious composite 10 to various substrates (e.g., dirt, grass, gravel, etc.). In some embodiments, outer side 54 is coated with an adhesive and covered by a removable liner. The removable liner may be removed during installation such that the adhesive on outer side 54 of impermeable layer 50 attaches cementitious composite 10 to a respective substrate.

According to an alternative embodiment, impermeable layer 50 includes a geomembrane. Such a geomembrane may include various materials (e.g., synthetic sheeting, single-ply membrane, another type of membrane used for waterproofing, etc.). According to an exemplary embodiment, the geomembrane includes a polyolefin film having a thickness of between 0.075 and 2.5 millimeters. According to an exemplary embodiment, impermeable layer 50 includes extruded polypropylene or a reinforced polypropylene that provides improved puncture resistance and tensile strength relative to other materials. Reinforced materials (e.g., externally reinforced with nonwoven polyester fabric, internally reinforced with polyester scrim, reinforced with a woven fabric, reinforced with a non-woven fabric, a geogrid, or otherwise reinforced) allow for the use of a thinner membrane thereby reducing the overall weight or thickness of cementitious composite 10. Specific exemplary polypropylene films include TT422 and TG 4000 as manufactured by Colbond or UltraPly TPO XR 100 as manufactured by Fireston. In other embodiments, the film includes a coated membrane, such as Transguard 4000 as manufactured by Reef Industries.

According to an alternative embodiment, impermeable layer 50 may include another material (e.g., bituminous geomembrane, ethylene propylene diene monomer, low-density polyethylene, high-density polyethylene, polyvinyl chloride, polyurea and polypropylene, etc.). The material selected for impermeable layer 50 may have characteristics that improve the pliability, installation procedures, lifespan, and/or performance of cementitious composite 10. By way of example, polyvinyl chloride is flexible and may conform to uneven surfaces without tearing. According to an exemplary embodiment, a specific manufacturing technique, tensile strength, and/or ductility may be selected for impermeable layer 50 to best suit a particular application of cementitious composite 10.

According to still another alternative embodiment, impermeable layer 50 may include a coating (e.g., elastomeric coatings, acrylic coatings, butyl rubber coatings, Hypalon® coatings, Neoprene® coatings, silicone coatings, modified asphalt coatings, acrylic lacquer coatings, urethane coatings, polyurethane coatings, polyurea coatings, one of various coatings approved for potable water, any combination of two or more coating materials, etc.) that may be applied through various known techniques (e.g., spraying, etc.). It should be understood that the thickness, material selections, and other discussion regarding permeable layer 20 are applicable to impermeable layer 50. In one embodiment, impermeable layer 50 has a thickness of between four and one hundred millimeters, for example, ten millimeters. According to an exemplary embodiment, permeable layer 20, impermeable layer 50, and the side portions of cementitious composite 10 include the same coating material. According to an alternative embodiment, permeable layer 20 and impermeable layer 50 include different coating materials. In either embodiment, permeable layer 20 and impermeable layer 50 may be applied simultaneously or successively.

According to still another alternative embodiment, cementitious composite 10 does not include an impermeable layer 50 and instead includes an additional permeable layer. Such a permeable layer may allow cementitious composite 10 to fuse with substrates (e.g., existing concrete structures, etc.). By way of example, a permeable material may allow cementitious mixture 30 and/or cementitious mixture 130 to partially diffuse post-in-situ hydration and bond with a substrate below. External curing processes, internal curing processes (e.g., curing performed with compounds such as liquid polymer additives, etc.), or various additives in cementitious mixture 30 and/or cementitious mixture 130, may further improve the bond between cementitious composite 10 and a substrate.

### Membrane Layer

According to the exemplary embodiment shown in FIGS. 13, 14A-18, 20B, and 20C, cementitious composite 10 includes a membrane layer, shown as membrane 190, coupled to impermeable layer 50. In other embodiments, cementitious composite 10 does not include membrane 190. Membrane 190 may be coupled to impermeable layer 50 before or after a quilting or needle punching process. Membrane 190 may be coupled to impermeable layer 50 using adhesive or a heating process (e.g., to melt the membrane 190 and/or impermeable layer 50 together to form a single layer, etc.). Membrane 190 may further waterproof impermeable layer 50 and/or prevent chemicals (e.g., sulfate, etc.) from permeating therethrough from the soil upon which cementitious composite 10 may be disposed. Membrane 190 may be manufactured from various suitable materials and/or have varying thickness. Membrane 190 may include scrims or other materials for increased strength.

### Single Outer Layer

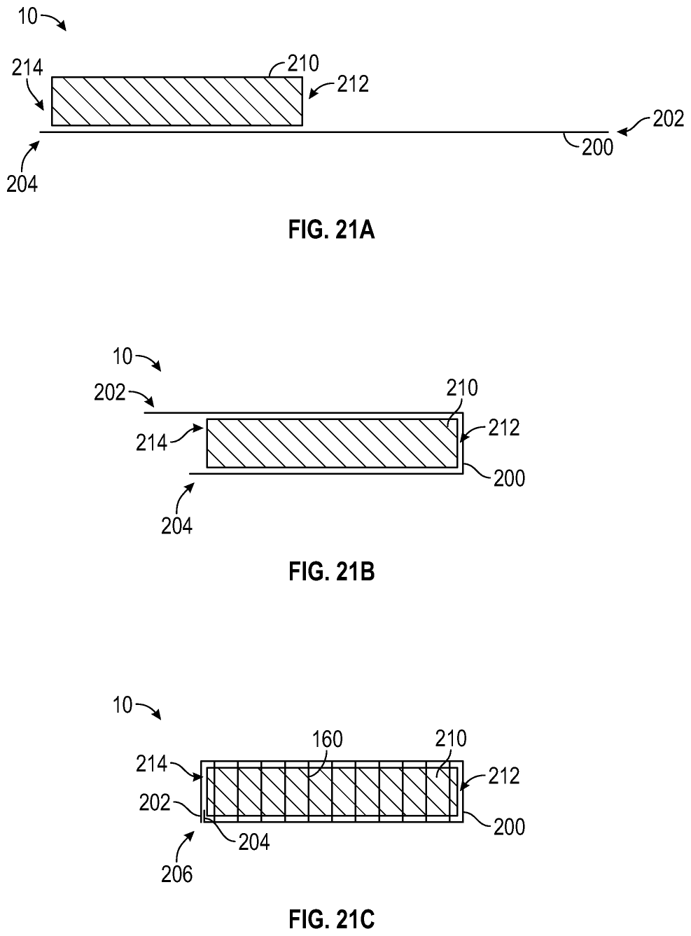

According to the exemplary embodiment shown in FIGS. 21A-21C, cementitious composite 10 includes a single outer layer, shown as outer layer 200, and contents, shown as internal contents 210. Outer layer 200 may be the same and/or have similar characteristics as permeable layer 20 and/or impermeable layer 50. Internal contents 210 may be and/or include cementitious mixture 30, cementitious mixture 130, and/or structure layer 40. As shown in FIGS. 21A-21C, (i) outer layer 200 includes a first end, shown as end 202, and a second end, shown as end 204, and (ii) internal contents 210 have a first end, shown as end 212, and an opposing second end, shown as end 214.

As shown in FIG. 21A, internal contents 210 may be disposed along at least a portion of outer layer 200 (e.g., proximate the end 204, proximate the end 202, anywhere between the end 202 and the end 204, etc.). As shown in FIG. 21B, end 202 of outer layer 200 is folded over internal contents 210 (e.g., over end 212 toward end 214, creating a closed end in cementitious composite 10 at end 212 of internal contents 210 and an open end in cementitious composite 10 at end 214 of internal contents 210, etc.). In some embodiments, end 204 is additionally or alternatively folded over internal contents 210.

As shown in FIG. 21C, end 202 and end 204 of outer layer 200 are coupled (e.g., joined, bonded, etc.) to form a seam, shown as seam 206, enclosing internal contents 210 within outer layer 200. As shown in FIG. 21C, end 204 of outer layer 200 is wrapped upward and thereafter joined with end 202 of outer layer 200 at seam 206. In other embodiments, end 204 of outer layer 200 is wrapped under internal contents 210 (e.g., on the inside of end 204 of outer layer 200, on the outside of end 204 of outer layer 200, etc.) and thereafter joined with end 202 of outer layer 200 at seam 206 (i.e., seam 206 may be below, on the side of, or above internal contents 210). In some embodiments, end 202 and end 204 of outer layer 200 are pinched together (e.g., without wrapping around end 212, etc.) and then bonded together (e.g., with adhesive, heat, ultrasonic, sewed stapled, etc.). In some embodiments, internal contents 210 extends continuously along the length of cementitious composite 10. In other embodiments, outer layer 200 forms discrete pockets within cementitious composite 10. End 202 and end 204 of outer layer 200 may be joined using adhesive, using a heat treatment process, ultrasonically, sewn, stapled, taped, caulked, and/or still otherwise bonded together. As shown in FIG. 21C, securing layer 160 may be formed within cementitious composite 10 using a quilting process (e.g., using strands 162, etc.) and/or a needle punching process (e.g., pulling fibers 170, etc.) to secure outer layer 200 around internal contents 210. In some embodiments, cementitious composite 10 of FIG. 21C additionally or alternatively includes interconnecting structure 140, pins (e.g., of structure layer 40, see International Patent Application No. PCT/US2016/060684, etc.), and/or staples (e.g., of structure layer 40, see International Patent Application No. PCT/US2016/060684, etc.) to secure outer layer 200 around internal contents 210.

### Manufacture

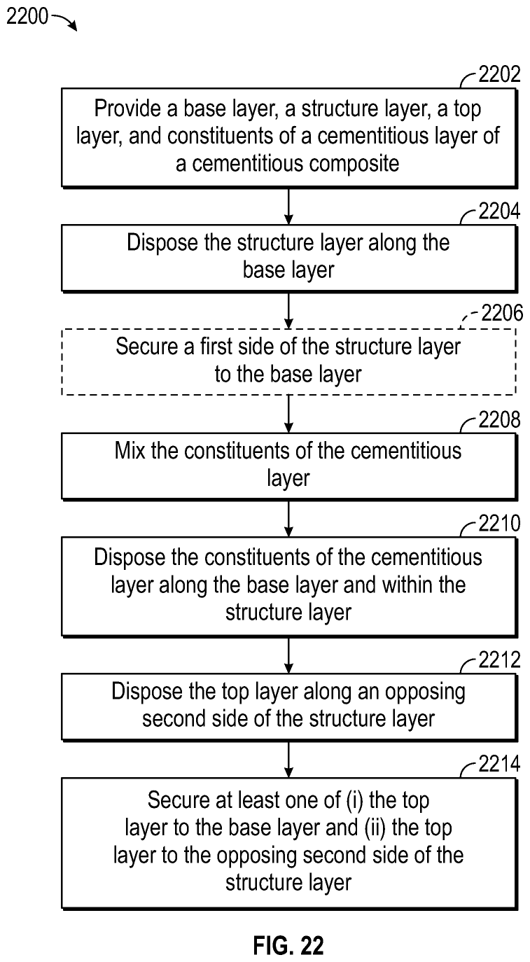

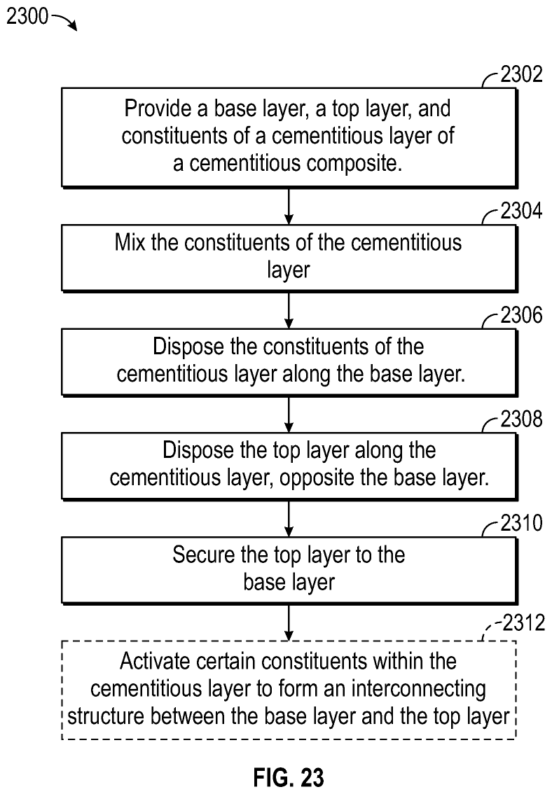

Referring to FIGS. 22 and 23, cementitious composite 10 may be manufactured using a line assembly machine, which may operate continuously or may engage in an indexed operation mode where material is fed, stopped (e.g., to allow the machine to perform an operation), and thereafter again feed. According to an exemplary embodiment, FIGS. 22 and 23 are various methods for manufacturing cementitious composite 10 of FIGS. 13-20C.

Referring now to FIG. 22, a method 2200 for manufacturing a cementitious composite is shown, according to an exemplary embodiment. At process 2202, a base layer (e.g., impermeable layer 50, etc.), a top layer (e.g., permeable layer 20, etc.), a structure layer (e.g., structure layer 40, etc.), and constituents (e.g., cementitious materials 32, aggregates 34, absorbent material 36, etc.) of a cementitious layer (e.g., cementitious mixture 30, etc.) of the cementitious composite (e.g., cementitious composite 10, etc.) are provided. At process 2204, the structure layer is disposed along the base layer. At process 2206, a first side (e.g., a bottom surface, etc.) of the structure layer is secured to the base layer via a securing process (e.g., using lower strand 166, a quilting process, a needle punching process, etc.). In some embodiments, method 2200 does not include process 2206.

At process 2208, the constituents of the cementitious layer are mixed. The mixing may evenly distribute the constituents. The constituents may be mixed together in a container or hopper. At process 2210, the constituents of the cementitious layer are disposed along the base layer and within the structure layer. By way of example, the hopper or container may include a dispenser/distributor that deposits the constituents onto the base layer and within the structure layer as the impermeable layer and the structural layer pass below the dispenser. The dispenser/distributor may be shaped (e.g., rectangular, adjustable, biased-cut, etc.) to facilitate even distribution of the constituents. In one embodiment, the base layer and the structure layer pass over a vibratory table configured to vibrate to further facilitate even distribution and/or compaction of the constituents to form a uniform cementitious layer within the structure layer. In other embodiments, the constituents are compressed into the structure layer. According to an exemplary embodiment, the base layer and the structure layer having received the constituents from the dispenser thereafter passes over a compactor. In one embodiment, the compactor includes rollers. In some embodiments, the rollers are configured to compress the constituents with a pressure of between 200 and 10,000 pounds per square inch. Such rollers may replace the vibratory table or may be positioned before, after, or with the vibratory table. Rollers may also move the base layer, structure layer, and the cementitious layer. In other embodiments, the compactor includes a hydraulic press or other type of physical compactor. In an alternative embodiment, compactor incorporates a vacuum system configured to draw cementitious material into a prescribed shape.

At process 2212, a top layer (e.g., permeable layer 20, etc.) is disposed along an opposing second side (e.g., a top surface, opposite the base layer, etc.) of the structure layer. The top layer may include a film, sheet, or other configuration of material applied to form an upper containment layer around the cementitious layer. By way of example, the top layer may include a water soluble material (e.g., a cold water soluble material, etc.). In some embodiments, the water soluble material is a fabric material. Such a fabric material may be woven or nonwoven. In one embodiment, the fabric material is a cold water soluble nonwoven material manufactured from partially hydrolyzed polyvinyl alcohol fibers (e.g. a PVA fabric, etc.). The top layer may be applied as part of a continuous process, where the base layer and top layer are moved at a common speed. At process 2214, at least one of (i) the top layer is secured to the base layer via a securing process (e.g., using strand 162, a quilting process, a needle punching process, etc.) and (ii) the top layer is secured to the opposing second side of the structure layer via a securing process (e.g., using the upper strand 164, a quilting process, a needle punching process, etc.).

According to an exemplary embodiment, a sealing system is configured to seal the sides and ends of the cementitious composite. Such a sealing system may include sprayers configured to apply a coating to the sides and ends of the cementitious layer, a roller configured to fold a portion of the impermeable layer and/or the permeable layer over the sides and ends, or another system. According to an exemplary embodiment, sealing the sides and ends the cementitious layer further contains the constituents within the cementitious composite and prevents the constituents from migrating from the cementitious composite (e.g., during handling, transportation, installation, etc.).

According to an exemplary embodiment, a take-up roll is configured to roll the cementitious composite around a core. According to an exemplary embodiment, the core is coupled to a driver to rotate and apply a driving force that draws the cementitious composite. According to an exemplary embodiment, the cementitious composite is vacuum sealed as an entire roll. According to an alternative embodiment, sheets of cementitious composite may be vacuum sealed individually or as a stacked group. Such sealing facilitates transportation and handling of the cementitious composite.

Referring now to FIG. 23, a method 2300 for manufacturing a cementitious composite is shown, according to an exemplary embodiment. At process 2302, a base layer (e.g., impermeable layer 50, etc.), a top layer (e.g., permeable layer 20, etc.), and constituents (e.g., cementitious materials 32, aggregates 34, absorbent material 36, beads 132, aggregates 134, cementitious materials 136, additives, etc.) of a cementitious layer (e.g., cementitious mixture 30, cementitious mixture 130, etc.) of the cementitious composite (e.g., cementitious composite 10, etc.) are provided. At process 2304, the constituents of the cementitious layer are mixed together. The mixing may evenly distribute the constituents. The constituents may be mixed together in a container or hopper. At process 2306, the constituents of the cementitious layer are disposed along the base layer. By way of example, the hopper or container may include a dispenser/distributor that deposits the constituents onto the base layer as the base layer passes below the dispenser. The dispenser/distributor may be shaped (e.g., rectangular, adjustable, biased-cut, etc.) to facilitate even distribution of the constituents onto the base layer. In one embodiment, the base layer passes over a vibratory table configured to vibrate to further facilitate even distribution and/or compaction of the constituents to form a uniform cementitious layer. In some embodiments, at least one of the constituents and the base layer are compressed to compact the constituents into the cementitious layer. According to an exemplary embodiment, the base layer having received the constituents from the dispenser thereafter passes over a compactor. In one embodiment, the compactor includes rollers. In some embodiments, the rollers are configured to compress the constituents with a pressure of between 200 and 10,000 pounds per square inch. Such rollers may replace the vibratory table or may be positioned before, after, or with the vibratory table. Rollers may also move the base layer and cementitious layer. In other embodiments, the compactor includes a hydraulic press or other type of physical compactor. In an alternative embodiment, compactor incorporates a vacuum system configured to draw cementitious material into a prescribed shape. In another alternative embodiment, the compactor incorporates a compressed air system.

At process 2308, a top layer is disposed along the cementitious layer, opposite the base layer. The top layer may include a film, sheet, or other configuration of material applied to form an upper containment layer around the cementitious layer. By way of example, the top layer may include a water soluble material (e.g., a cold water soluble material, etc.). In some embodiments, the water soluble material is a fabric material. Such a fabric material may be woven or nonwoven. In one embodiment, the fabric material is a cold water soluble nonwoven material manufactured from partially hydrolyzed polyvinyl alcohol fibers (e.g. a PVA fabric, etc.). At process 2310, the top layer is secured to the base layer via a securing process (e.g., using strand 162, a quilting process, a needle punching process, fibers 170, etc.). The top layer may be applied as part of a continuous process, where the base layer and top layer are moved at a common speed. In an alternative embodiment, the top layer is an impermeable material that is disposed along the cementitious layer and thereafter punctured (e.g., to make the second layer permeable, etc.).

At process 2312, at least one of the base layer and the top layer are heated to activate certain constituents (e.g., beads 132, etc.) within the cementitious layer (e.g., cementitious mixture 130, etc.) to form an interconnecting structure (e.g., interconnecting structure 140, etc.). The interconnecting structure may attach to at least one of the base layer and the top layer to form the cementitious composite. In some embodiments, process 2312 is performed prior to process 2310. In some embodiments, method 2300 does not include process 2312 (e.g., in embodiments where cementitious composite 10 includes cementitious mixture 30, etc.). According to an exemplary embodiment, the base layer and/or the top layer are bonded to the interconnecting structure with the application of heat (e.g., with a heated roller, with a heated air stream, with a hot plate, with a furnace, etc.) as part of the continuous process. Pressure may be applied to the base layer and/or the top layer (e.g., with a roller) as part of the heating processes or after heating (e.g., with a cooling roller) to produce a tight composite material (e.g., a cementitious composite with low void space between the first layer and the second layer, etc.).

According to an exemplary embodiment, a sealing system is configured to seal the sides and ends of the cementitious composite mat. Such a sealing system may include sprayers configured to apply a coating to the sides and ends of the cementitious layer, a roller configured to fold a portion of the base layer and/or the top layer over the sides and ends, or another system. According to an exemplary embodiment, sealing the sides and ends the cementitious layer further contains the constituents within the cementitious composite and prevents the constituents from migrating from the cementitious composite (e.g., during handling, transportation, installation, etc.).

According to an exemplary embodiment, a take-up roll and/or winder is configured to roll the cementitious composite mat around a core. According to an exemplary embodiment, the core is coupled to a driver to rotate and apply a driving force that draws the cementitious composite mat. According to an exemplary embodiment, the cementitious composite mat is vacuum sealed as an entire roll or otherwise packaged with air tight and/or water tight packaging. According to an alternative embodiment, sheets of cementitious composite mat may be vacuum sealed individually or as a stacked group. Such sealing facilitates transportation and handling of the cementitious composite mat.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It should be noted that the orientation of various elements may differ according to other exemplary embodiments and that such variations are intended to be encompassed by the present disclosure.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Additionally, in the subject description, the word “exemplary” may be used to mean serving as an example, instance or illustration. Any embodiment or design described herein as “exemplary” may be not necessarily to be construed as preferred or advantageous over other embodiments or designs. Rather, use of the word exemplary may be intended to present concepts in a concrete manner. Accordingly, all such modifications are intended to be included within the scope of the present inventions. The order or sequence of any process or method steps may be varied or re-sequenced according to alternative embodiments. Any means-plus-function clause may be intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or the appended claims.

1. A cementitious composite for in-situ hydration, the cementitious composite comprising:
a first layer;
a cementitious mixture disposed along the first layer, the cementitious mixture including a plurality of cementitious particles;
a second layer disposed along the cementitious mixture, opposite the first layer; and
an adhesive layer positioned to secure at least one of (i) the first layer to the cementitious mixture, (ii) the second layer to the cementitious mixture, and (iii) the first layer and the second layer together;
wherein the first layer and the second layer are configured to at least partially prevent the plurality of cementitious particles from migrating out of the cementitious composite;
wherein the adhesive layer includes an adhesive that coats a plurality of particles of the cementitious mixture to form a plurality of adhesive particles within the cementitious mixture;
wherein the plurality of adhesive particles are configured to at least one of melt, fuse, deform, and expand in response to activation; and
wherein the activation of the plurality of adhesive particles causes the plurality of adhesive particles to form an interconnected structure within the cementitious mixture that attaches to at least one of the first layer and the second layer.

2. The cementitious composite of claim 1, wherein the adhesive layer includes a non-water based adhesive.

3. The cementitious composite of claim 1, further comprising a structure layer disposed between the first layer and the second layer, the structure layer secured to at least one of the first layer and the second layer by the adhesive layer.

4. The cementitious composite of claim 1, wherein the adhesive layer comprises a first adhesive layer positioned between the first layer and the cementitious mixture, further comprising a second adhesive layer positioned between the second layer and the cementitious mixture.

5. A cementitious composite for in-situ hydration, the cementitious composite comprising:
a first layer;
a cementitious mixture disposed along the first layer, the cementitious mixture including a plurality of cementitious particles;
a second layer disposed along the cementitious mixture, opposite the first layer; and
an adhesive layer positioned to secure at least one of (i) the first layer to the cementitious mixture, (ii) the second layer to the cementitious mixture, and (iii) the first layer and the second layer together;
wherein the first layer and the second layer are configured to at least partially prevent the plurality of cementitious particles from migrating out of the cementitious composite; and
wherein the adhesive layer includes a plurality of discrete connectors that extend between the first layer and the second layer, wherein the plurality of discrete connectors are formed from an adhesive that has cured.

6. A cementitious composite for in-situ hydration, the cementitious composite comprising:
a first layer;
a cementitious mixture disposed along the first layer, the cementitious mixture including a plurality of cementitious particles;
a second layer disposed along the cementitious mixture, opposite the first layer; and
an adhesive layer positioned to secure at least one of (i) the first layer to the cementitious mixture, (ii) the second layer to the cementitious mixture, and (iii) the first layer and the second layer together;
wherein the first layer and the second layer are configured to at least partially prevent the plurality of cementitious particles from migrating out of the cementitious composite; and
wherein the adhesive layer comprises a rigid, three-dimensional structure formed from an adhesive that has cured; and
wherein (i) a first side of the rigid, three-dimensional structure is adhesively secured to the first layer and (ii) a second side of the rigid, three-dimensional structure is adhesively secured to the second layer using a heating process.

7. (canceled)

8. A cementitious composite for in-situ hydration, the cementitious composite comprising:
a first layer;
a cementitious mixture disposed along the first layer, the cementitious mixture including a plurality of cementitious particles; and
a second layer disposed along the cementitious mixture, opposite the first layer;
wherein the first layer and the second layer are configured to at least partially prevent the plurality of cementitious particles from migrating out of the cementitious composite; and
wherein the first layer and the second layer are secured to at least one of a structure layer and each other using at least one of a quilting process and a needle punching process.

9. The cementitious composite of claim 8, wherein the first layer and the second layer are secured to at least one of the structure layer and each other using the quilting process.

10. The cementitious composite of claim 9, further comprising a strand that is sewn into the cementitious composite during the quilting process, the strand extending between the first layer and the second layer to secure the first layer and the second layer together.

11. The cementitious composite of claim 9, further comprising the structure layer, the structure layer disposed between the first layer and the second layer.

12. The cementitious composite of claim 11, further comprising at least one of a first strand and a second strand that are sewn into the cementitious composite during the quilting process, the first strand securing the first layer to a first side of the structure layer and the second strand securing the second layer to an opposing second side of the structure layer.

13. The cementitious composite of claim 12, wherein the cementitious composite includes both the first strand and the second strand.

14. The cementitious composite of claim 8, wherein the first layer and the second layer are secured to each other using the needle punching process.

15. The cementitious composite of claim 14, further comprising a plurality of fibers that extend between the first layer and the second layer to secure the first layer and the second layer together, wherein the plurality of fibers are pulled from at least one of the first layer and the second layer during the needle punching process.

16. The cementitious composite of claim 15, wherein the plurality of fibers are pulled from both the first layer and the second layer.

17. The cementitious composite of claim 8, further comprising a membrane coupled to an exterior surface of the first layer, the membrane configured to at least one of waterproof the first layer and prevent chemicals from permeating therethrough from a ground surface upon which the cementitious composite is disposed.

18-20. (canceled)
